(19) United States
(12) Patent Application Publication
(10) Pub. No.: US 2024/0111147 A1
(43) Pub. Date: Apr. 4, 2024

(54) High Altitude Aerial Mapping

(71) Applicant: SIMPLEX MAPPING SOLUTIONS SB LTD., Herzliya (IL)

(72) Inventors: Shahar Barnea, Kiriat Ono (IL); Ziv Shragai, Herzliya (IL)

(73) Assignee: SIMPLEX MAPPING SOLUTIONS SB LTD, Herzliya (IL)

(21) Appl. No.: 18/531,794

(22) Filed: Dec. 7, 2023

Related U.S. Application Data
(63) Continuation-in-part of application No. 16/233,146, filed on Dec. 27, 2018.
(60) Provisional application No. 63/521,102, filed on Jun. 15, 2023.

(51) Int. Cl. G02B 26/08; B64D 47/08; G03B 15/00; G03B 17/56; G03B 35/08; H04N 13/239; H04N 13/243; H04N 23/58

(52) U.S. Cl. CPC G02B 26/0816; B64D 47/08; G03B 15/006; G03B 17/561; G03B 35/08; H04N 13/239; H04N 13/243; H04N 23/58

(57) ABSTRACT

The present invention describes an aerial survey camera system. The system includes two or more cameras mounted on a bracket and one or mirrors that are rotated simultaneously perpendicular to the aircraft's movement by a motor. Mirrors may be driven and/or synchronized on separate shafts using a low recoil band. The motor positions the cameras in the planned angles and stops their rotation, while the controller commands the cameras to capture the images. Optionally the aircraft crosses an area of interest in parallel lines of flight at opposite directions, for example to facility covering all viewing angles with a small number of cameras. The invention further discloses methods for efficient flight management utilizing the disclosed system.

### RELATED APPLICATION/S

This application is a Continuation in Part of U.S. patent application Ser. No. 16/233,146 filed 27 Dec. 2018

This application claims the benefit of priority under 35 USC § 119(e) of U.S. Provisional Patent Application No. 63/521,102 filed 15 Jun. 2023, the contents of which are incorporated herein by reference in their entirety.

This application claims the benefit of priority of U.S. patent application Ser. No. 16/233,146 filed 27 Dec. 2018 and U.S. Provisional Patent Application No. 63/521,102 filed 15 Jun. 2023, the contents of which are incorporated herein by reference in their entirety.

The contents of the above applications are all incorporated by reference as if fully set forth herein in their entirety.

### FIELD AND BACKGROUND OF THE INVENTION

The present invention in some embodiments thereof relates to a sweeping aerial mapping technology and, more particularly, but not exclusively, to a sweeping aerial mapping technology utilizing mirrors.

US Patent Application publication no. 20200210676 appears to disclose, “an aerial survey camera system. The system includes two or more cameras mounted on a bracket that rotates perpendicular to the aircraft's movement by a motor. The images are captured at specific calculated angular intervals during the camera's sweeps. The motor positions the cameras in the planned angles and stops their rotation, while the controller commands the cameras to capture the images. Optionally the aircraft crosses an area of interest in parallel lines of flight at opposite directions, for example to facility covering all viewing angles with a small number of cameras. The invention further discloses methods for efficient flight management utilizing the disclosed system.”

US Patent Application publication no. 20170244880 appears to disclose, “An aerial camera system . . . that comprises at least one camera arranged to capture a plurality of successive images. Each camera including at least one respective image sensor, and the field of view of each camera is movable in a substantially transverse direction across a region of the ground. The system also includes a stabilization assembly associated with each camera that has at least one steering mirror. The steering mirror is controllably movable so as to translate the optical axis of the camera relative to the at least one image sensor in synchronization with image capture, so as to effect stabilization of an image on the at least one image sensor during image capture as the field of view of the camera moves in a substantially transverse direction across a region of the ground. The system is arranged to control the at least one camera to capture successive images at defined intervals as the field of view of the camera moves in a substantially transverse direction across a region of the ground.

US Published Patent Application no. 20150022656 appears to disclose that, “A system for guided geospatial image capture, registration and 2D or 3D mosaicking, that employs automated imagery processing and cutting-edge airborne image mapping technologies for generation of geo-referenced Orthomosaics and Digital Elevation Models from aerial images obtained by UAVs and/or manned aircraft.”

U.S. Pat. No. 9,751,639 appears to disclose, “A camera triggering and aerial imaging mission visualization system. More specifically, a system that controls camera triggering, manages data from a positioning system and an attitude measuring device, and provides real-time image coverage and mission visualization in manned and unmanned aerial imaging applications. The system includes a control and data management device that interfaces with at least one camera; one or more positioning systems; one or more attitude measuring devices; one or more data transmission devices; and a mission visualization system. The aerial imaging system may be interfaced with a variety of commercial, off-the-shelf or custom cameras for use in aerial imaging on manned and unmanned aircrafts, and may also be used on other types of vehicles or for other applications.”

U.S. Pat. No. 8,717,418 appears to disclose that, “By defining an angular separation in a train of sequential images, and using an interlaced sequence of pairs of images matched by that defining angle, it is possible to create live 3D video from a single camera mounted on a remote vehicle as though in the in the immediate vicinity of the object being viewed. Such a camera can be mounted on a moving vehicle such as a plane or a satellite. In addition, computational power is provided to adaptively (and predictively) smooth out motion irregularities between these image pairs, so that smooth 3D video may be obtained. Continual feature-based correlation between successive frames allows corrections for various transformations so that there is a one-on-one correspondence in size, projection, orientation, etc. between matched frames, which enables capture and display of smooth 3D video.”

U.S. Pat. No. 7,509,241 appears to disclose, “A method and apparatus for automatically combining aerial images and oblique images to form a three-dimensional (3D) site model. The apparatus or method is supplied with aerial and oblique imagery. The imagery is processed to identify building boundaries and outlines as well as to produce a depth map. The building boundaries and the depth map may be combined to form a 3D plan view model or used separately as a 2D plan view model. The imagery and plan view model is further processed to determine roof models for the buildings in the scene. The result is a 3D site model having buildings represented rectangular boxes with accurately defined roof shapes.”

Midas-5 Manual 2010-2015 available from LEAD'AIR INC, 113 S. Hoagland Boulevard, KISSIMMEE FLORIDA 34741, TrackAir.com+1 (407) 343-7571 http://trackair.com/wp-content/uploads/2015/10/MIDAS_5.pdf appears to disclose, “a rigid construction, specifically engineered for precise mounting of a single camera type. The cameras themselves are based on the highest resolution image platforms available on the professional market . . . . In order to achieve this scientific-grade optical performance from these systems, the lens mounts must be replaced with a rigid assembly guaranteeing alignment and stability after final assembly. This is the Lead ‘Air “CAM-LENS” solution. The CAM-LENS mounting hardware then allows each imaging assembly to be precisely located in the oblique mounting jig, to form an indissociable array unit. The ruggedized optical mounts of each of the five cameras are permanently mounted together in precise alignment in a geometrically orthogonal array, machined to instrument standard precision . . . . ”

US Published Patent Application no. 20100277587 appears to disclose, “Apparatus for capturing images while in motion, including at least one CCD camera housed within an aircraft traveling along a flight path, for capturing aerial images of ground terrain, a motor for rotating an axis on which the at least one CCD camera is mounted, and for generating a sweeping back-and-forth motion for a field of view of the at least one CCD camera, the sweeping motion being transverse to the aircraft flight path, and an optical assembly connected to said at least one CCD camera.”

Additional background art includes U.S. Pat. Nos. 9,269,187, 8,723,953, 9,618,934 and 9,600,936, Chinese Utility Model CN203740138U, U.S. Pat. No. 5,999,211.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### SUMMARY OF THE INVENTION

According to an aspect of some embodiments of the invention, there is provided a system for three-dimensional mapping including: a first camera imaging through a first lens of at least 180 mm focal length; a second camera imaging through a second lens of at least 300 mm focal length, wherein a focal length of the second lens is greater than a focal length of the first lens; a first mirror sweeping a field of view of the first camera in a direction between 80 to 90 degrees of an axis of sweeping; a second mirror sweeping a field of view of the second camera in a direction between 45 to 80 degrees of a second axis of sweeping wherein the first axis of sweeping and the second axis of sweeping are at least one of parallel and colinear; wherein sweeping of the first mirror and the second mirror are synchronized.

According to some embodiments of the invention, the first axis of sweeping and the second axis of sweeping are parallel and movement of the first mirror is synchronized to movement of the second mirror by a low recoil belt.

According to some embodiments of the invention, a single actuator drives movement of both the first mirror and second mirror.

According to some embodiments of the invention, the system at least one point of the low recoil belt is permanently connected to a drive driving movement of at least one of the first mirror and the second mirror.

According to some embodiments of the invention, the system further includes a third camera and a third mirror sweeping a field of view of the third camera and wherein an axis of sweeping of the third mirror is colinear with at least one of the axis of sweeping of the first mirror and the axis of sweeping of the second mirror.

According to some embodiments of the invention, the system further includes a third lens of a focal length of at least 300 mm and having a focal length greater than the first lens and wherein the third camera images through the third lens.

According to some embodiments of the invention, the third mirror directs the field of view of the third cameral at an angle between 45 to 80 degrees from the axis of sweeping of the third mirror and in a direction opposite an angle between the field of view of the second camera and the second axis of sweeping.

According to some embodiments of the invention, the system further includes an aircraft and wherein the first axis of sweeping is parallel to a line of flight of the aircraft.

According to an aspect of some embodiments of the invention, there is provided an imaging system for aerial 3D mapping including: a camera bracket configured to hold exactly one nadir camera exactly one oblique camera rigidly immobile with respect to each other; an actuator configured for simultaneously for sweeping a field of view of the nadir camera at an angle fixed nearly perpendicular to a single axis of the sweeping and the oblique camera at an acute angle fixed with respect to the axis of sweeping thereby sweeping the field of view of the nadir camera over three directions and the field of view of the oblique camera over three directions; a servo bracket holding the actuator and the camera bracket to an aircraft with the single axis of sweeping fixed parallel to a longitudinal axis of the aircraft; a processor configured to control the sweeping as the aircraft passes over a region on a plurality of parallel lines of flight wherein the on each of the parallel lines of flight the aircraft passes only once in one of two opposite directions to capture overlapping images in only six directions on each of the plurality of parallel line of flight and to achieve overlapping views of the region in exactly nine directions over the plurality of lines of flight.

According to some embodiments of the invention, the nadir camera is held by the camera bracket at an angle of between 80 to 100 degrees to the single axis of sweeping.

According to some embodiments of the invention, the oblique camera is held at an oblique angle to the single axis of sweeping of between 15 to 75 degrees.

According to some embodiments of the invention, the camera bracket further holds a lens of at least one camera of the oblique camera and the nadir camera immobile with respect to a body of the at least one camera.

According to some embodiments of the invention, the servo bracket is mounted to an underside of the aircraft.

According to some embodiments of the invention, the camera bracket holds one of the nadir camera and the oblique camera translated transversely with respect to another of the at least two cameras with respect to the axis of sweeping.

According to some embodiments of the invention, the camera bracket is height adjustable to relative to the aircraft.

According to some embodiments of the invention, the oblique camera points in only one of forward or backwards directions.

According to some embodiments of the invention, the system includes a stabilizer.

According to some embodiments of the invention, the system does not include any oblique camera facing in a longitudinal direction other than longitudinal direction of the single nadir camera.

According to some embodiments of the invention, the system does not include any oblique camera facing in a longitudinal direction opposite the single longitudinal direction.

According to some embodiments of the invention, the only six directions consist of three nadir left, nadir right and nadir directly down and exactly one of a first set three oblique directions and a second sets of three oblique directions wherein a first set of three oblique directions consists of forward left, forward right and directly forward and wherein a second set of three oblique directions consists of rearward left, rearward right and directly rearward.

According to some embodiments of the invention, on a line of flight in a first direction the system captures images from three directions consisting of nadir left, nadir right, nadir directly down, in a given direction left, in the given direction right and angled down straight in the given direction and wherein on a line of flight in a direction opposite the first direction the system captures images from nadir left, nadir right, nadir directly down, in a direction opposite the given direction left, in the direction opposite the given direction right and angled down straight in the direction opposite the given direction.

According to an aspect of some embodiments of the invention, there is provided a method of imaging a region of interest including: traveling over the region of interest along parallel lines of flight (LoF's), wherein the traveling includes passing by each of two opposing sides of the region of interest on the LoF's in each of two opposing directions, while taking images directed along the LoF's in only one of a forward or backwards oblique direction wherein the forward or backwards oblique direction is at an angle of between 15 to 75 degrees to the LoF's; and sweeping a field of view (FOV) of the images transversely to form overlapping images from 6 oblique directions; wherein taking images in a nadir direction while passing over the region of interest on the LoF's and sweeping the FOV of the images transversely to form overlapping images from 3 directions, wherein the nadir direction is at an angle of between 80 to 100 degrees to the LoF's.

According to some embodiments of the invention, the overlapping images taken from the forward or backwards oblique and nadir direction are produced by exactly two cameras.

According to an aspect of some embodiments of the invention, there is provided a method of imaging a region of interest including: traveling by each of two opposing sides of the region of interest along parallel lines of flight (LoF's), wherein the traveling includes passing by each of two opposing sides of the region of interest on the LoF's in each of two opposing directions, while taking images directed along the LoF's in only one of a forward or backwards oblique direction wherein the forward or backwards oblique direction is at an angle of between 15 to 75 degrees to the LoF's; and sweeping a field of view (FOV) of the images transversely to form overlapping images from 6 oblique directions, taking images in a nadir direction while passing over the region of interest on the LoF's and sweeping the FOV of the images transversely to form overlapping images from 3 directions, wherein the nadir direction is at an angle of between 80 to 100 degrees to the LoF's.

According to some embodiments of the invention, the overlapping images taken from the forward or backwards oblique and nadir direction are produced by exactly two cameras.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1A is a schematic perspective view of a 3 camera embodiment in accordance with an embodiment of the current invention;

FIG. 1B is a schematic bottom view of a 3-camera embodiment in accordance with an embodiment of the current invention;

FIG. 1C is a bottom perspective view of a 3-camera system in accordance with an embodiment of the current invention;

FIG. 2A is a schematic perspective view of a 2-camera embodiment in accordance with an embodiment of the current invention;

FIG. 2B is a schematic bottom view of a 2-camera embodiment in accordance with an embodiment of the current invention;

FIG. 2C is a bottom perspective view of a side by side 2 camera system in accordance with an embodiment of the current invention;

FIG. 3 is a bottom perspective view of an axially aligned 2 camera system in accordance with an embodiment of the current invention;

FIG. 4 illustrates comparable resolution for nadir photographs at different altitudes using different lenses in accordance with an embodiment of the current invention;

FIG. 5 illustrates comparable resolution for a 90-degree (from +45 to −45 around a longitudinal horizontal axis) sweep of oblique photographs from hi and low altitude in accordance with an embodiment of the current invention.

FIG. 6 illustrates the overlapping FOV's of 2 sweeps of a three-camera system while traveling on a single flight line in accordance with an embodiment of the current system

FIG. 7 illustrates the overlapping FOV's of overlapping sweeps of a three-camera system while traveling on two parallel flight lines in accordance with an embodiment of the current system;

FIG. 8 schematically shows two LoF's while surveying a region of interest in accordance with an embodiment of the present invention;

FIG. 9 schematically shows 5 different perspectives of nadir and oblique views obtained by a system in accordance with an embodiment of the present invention;

FIG. 10 schematically shows 9 different perspective views of an object on the ground obtained by a system in accordance with an embodiment of the present invention;

FIG. 11 schematically shows coverage of a single image captured of a portion of the area of interest in accordance with an embodiment of the present invention;

FIGS. 12A and 12B illustrate sweeps containing 4 images by each camera and the respective coverage between images in accordance with an embodiment of the present invention;

FIGS. 13A-D schematically show the coverage of a building through four passes on parallel LoF's across a RoI in accordance with an embodiment of the current invention;

FIG. 13E illustrates covering a RoI with multiple parallel LoF's on accordance with an embodiment of the current invention;

FIG. 13F illustrates covering a RoI with a flight path including multiple parallel LoF's on accordance with an embodiment of the current invention;

FIG. 13G illustrates overlapping FoV's of an oblique forward facing camera during multiple parallel LoF's on accordance with an embodiment of the current invention;

FIG. 14 is a flow chart illustration of a method of acquiring images for a 3D map;

FIGS. 15 and 16 are block diagram of embodiments of the present invention. Two three or more cameras may be mounted to the mounting device;

FIG. 17 is a block diagram illustrating a system for aerial mapping in accordance with an embodiment of the current invention;

FIGS. 18A and 18B are schematic illustrations of a synchronizing system in accordance with an embodiment of the current invention;

FIG. 19 shows a perspective view of an example of a compact sweeping imaging system in accordance with an embodiment of the present invention;

FIG. 20 is a block diagram illustration of a mapping system in accordance with an embodiment of the present invention;

FIG. 21 is an exploded view of two imaging sensors enclosed in a bracket in accordance with an embodiment of the present invention;

FIG. 22 is a perspective view of a camera bracket and locker in accordance with an embodiment of the present invention;

FIG. 23 is a flow chart illustration of a method making images of a region of interest in accordance with an embodiment of the current invention;

FIG. 24 shows a schematic view of a servo motor and of a height adjustable plate in accordance with an embodiment of the present invention;

FIG. 25 shows a side view of the servo motor, camera bracket and the servo motor's bracket in accordance with an embodiment of the present invention;

FIGS. 26A to and 26B illustrate two alternative mounting geometries for two cameras in accordance with embodiment of the current invention; and

FIGS. 27 to 32 illustrate an embodiment of a 3D aerial photomapping imaging system in accordance with an embodiment of the current invention.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### DESCRIPTION OF SPECIFIC EMBODIMENTS OF THE INVENTION

### Overview

The present invention in some embodiments thereof relates to a sweeping aerial mapping technology and, more particularly, but not exclusively, to a sweeping aerial mapping technology utilizing mirrors.

An airplane performing aerial mapping optionally makes numerous passes in order to photograph a broad area. Optionally, to reduce the required number of passes may utilize cameras mounted on a rotating bracket. In some cases, a rotating camera system utilizes cameras equipped with standard focal-length lenses. In some embodiments, standard focal lenses limit the altitude from which the mapping is photographed. In some embodiments, a camera is equipped with high focal-length lens. For example, the focal length lens may facilitate taking photographs from a higher altitude. In some embodiments, taking photographs from a higher altitude, facilitates photographing a large area in fewer passes. Optionally, photographic an area in fewer passes may save time and/or expense. High-focal length lenses may be quite heavy.

An aspect of some embodiments of the current invention relates to an aerial mapping technology utilizing high focal-length lenses. The larger lenses may facilitate photography from a high altitude. For example, photographic from a higher altitude may enable the cameras to photograph a wider area on each pass than from a lower altitude. When each pass can photograph a greater area, this may reduce the number of passes required for mapping the area.

High focal-length lenses are heavy. In some embodiments, the weight of the lens may inhibit rotating the camera and lens with a rotating bracket. In some embodiments, the current invention may utilize a system of rotating mirrors to sweep the field of view. Optionally, the rotating a mirror facilitates sweeping the field of view (FOV) of a camera. For example, sweeping may include an oscillating back and forth sweeping. For example, the sweeping may be done without moving the camera and/or a heavy high focal length lens. In some embodiments, the mapping may be performed with the benefits of both higher-altitude mapping and sweeping the FOV.

In some embodiments of the current invention, the platform may be supplied with a nadir camera and/or an oblique camera. Optionally, each camera may have resolution ranging between 50 to 100 MP and/or between 100 to 150 MP and/or between 150 to 300 MP. Optionally, each camera may be capable of capturing between 1 to 2 and/or between 2 to 10 and/or between 10 to 20 frames per second FPS. The oblique cameras may be equipped with lenses having a focal length ranging between 100 to 250 mm and/or between 250 to 500 and/or between 500 to 1000 mm. Additionally or alternatively, the nadir camera may be equipped with a lens having a focal length ranging between 50 to 100 mm and/or between 100 to 250 mm and/or between 250 to 500 mm. In some embodiments, the focal length of the oblique lens may range between 0.8 to 1.3 and/or between 1.3 to 2.5 and/or between 2.5 to 5 times the focal length of the nadir lens. Some embodiments the current invention may provide for between 1 to 4 cm and/or between 4-6 cm and/or between 6 to 15 cm 3D mapping from an altitude of between 5,000 feet to 8,000 feet and/or between 8,000 feet to 12,000 feet and/or between 12,000 feet to 15,000 feet. In some embodiments, all of the cameras may have the same resolution, alternatively or additionally, they may have different resolutions. For example, one or more of the cameras may have a resolution between 5 to 50 megapixels and/or between 50 to 200 megapixels and/or between 200 to 400 megapixels and/or 400 to 1200 megapixels and/or between 1200 to 3600 megapixels. The current invention, in some embodiments thereof, may provide improved productivity/efficiency compared to the systems using smaller focal length lenses at lower altitudes. Some embodiments may provide improved views coverage per ground object and/or better 3D quality.

In some embodiments, the FOV of a camera may be swept across an area. For example, the sweeping may be perpendicular to a longitudinal axis and/or line of flight of the aircraft (e.g., at an angle between 89 to 90 degrees and/or between 85 to 90 degrees and/or between 60 to 90 degrees). For example, the sweeping may oscillate back and for rotation over an angle of about ±45 degrees for example ranging between −30 to +30 degrees and/or between −45 to +45 degrees and/or between −60 to +60 degrees (where 0 degrees is either straight down or parallel to the axis of sweeping and/or the longitudinal axis of the aircraft and/or the line of flight LoF).

In some embodiments, the sweeping may be driven by an actuator (e.g., a DC motor and/or a brushless DC actuator). For example, the actuator may drive a low recoil and/or low stretch belt (e.g., the belt may be made of metal). Optionally the belt is fixedly attached to a drive wheel. Optionally, the band may not be wrapped all the way around the wheel. For example, the band may be wrapped around less than 80% of the wheel and/or less than 50% of the wheel and/or less than 30% of the wheel. For example, a connection between the belt and the drive wheel is fixed (e.g., a pin and/or a screw etc.) and/or the oscillating movement of the wheel is small (e.g., less than 45 degrees and/or less than 30 degrees and/or less than 60 degrees and/or less than 90 degrees and/or less than 120 degrees). For example, this may mean that contact between the connected portion of the belt and drive wheel is not separated during oscillations and/or at least one point of connection between the belt may remain fixed throughout the oscillation cycle and/or the belt may not wind up on itself and/or the connection between the belt and the drive wheel may not depend on friction. Optionally, the belt and/or wheel may be made of material that is strong, durable, flexible, resistant to abrasion, resistant to oil, resistant to grease, resistant to heat and/or resistant to chemicals. For example, the belt and/or wheel may be made of metal, Polyurethane, Kevlar and/or carbon fiber. Optionally, the belt and/or drive wheel may be cogged and/or toothed. Optionally, the system may include a belt tension preserving system (e.g., a tensioner including for example an elastic member (e.g., a spring) and/or a sensor and/or controller to preserve belt tension).

In some embodiments, multiple mirrors are attached to a single axle to rotate synchronously. In some embodiments, mirrors are not coaxial but may be synchronized, for example, being driven by the same actuator. For example, each mirror may be mounted on its own axle and the axles may be driven by one or more belts. For example, FoV's of two or more cameras may rotate and/or be directed at the same angles in the traverse plane. For example, timing of image capture of two or more cameras may be simultaneous. For example, the two or more cameras may include a nadir camera and/or an oblique camera. For example, the two or more cameras may include a nadir camera and/or two oblique cameras. For example, the two or more cameras may include two oblique cameras. For example, the two or more cameras may include a nadir camera and/or multiple oblique cameras. For example, the two or more cameras may include multiple nadir cameras and/or one or more oblique cameras. For example, the two or more cameras may include multiple nadir cameras and/or multiple oblique cameras.

Optionally all the mirrors are synchronized. For example, they are all driven by a single actuator (e.g., electric motor, brushless motor etc.)

Optionally one or more low elasticity bands are used to drive the mirrors. The low elasticity of the bands may reduce backlash in the movement of the mirrors. For example, the bands may be metal bands. In some embodiments, the mirrors rotate over a range of less than 30 degrees and/or between 30 to 45 degrees and/or between 45 to 60 degrees and/or between 60 to 90 degrees and/or between 90 and 135 degrees and/or between 135 to 180 degrees. For example, the bands only drive a limited angle of movement. For example, the bank may be permanently attached to the drive wheels of the actuator and/or the mirrors (reducing slippage). This may make the back-and-forth movement more precise.

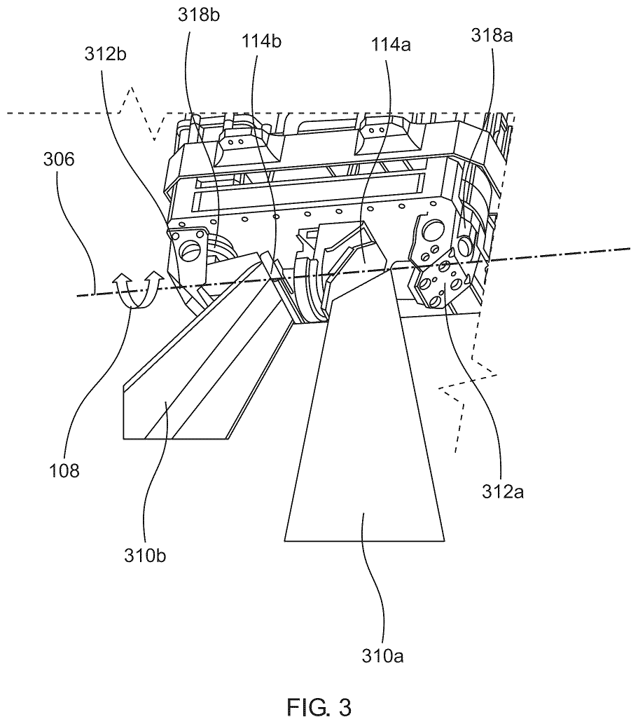

Optionally two mirrors may be mounted on one shaft. For example, in the two camera there may be only one shaft with mirrors mounted on opposite sides thereof (e.g., as illustrated in FIG. 3C). This may facilitate precise synchronization of the movement of the two mirrors

Some embodiments of the current invention may relate to the need for an imaging system in which the imaging sensors are not fixed in relation to the surface over which they are installed, to fine-tune the required imaging shooting angles during flight for obtaining the requested results while ensuring an efficient flight run.

An aspect of some embodiments of the current invention relates to a method of building a three-dimensional topography model using a two-cameras system and passing over the terrain over parallel paths. Optionally, the lines of sight of the two cameras are at a fixed angle one to another and/or are contained by a plane parallel to the path of travel. Optionally, the lines of sight of the cameras be swept along an angular path perpendicular to the line of travel. For example, while traveling along a line, the cameras may take pictures at many positions defining different angles of view of an object along the direction of travel. For example, the cameras may be swept along multiple angles to capture topography at multiple locations and/or different distances from the line of travel and/or at a different angle in a plane perpendicular to the LoF. For example, as pictures are made at different locations along different LoF's, each object may be photographed at a large number of different angles around each of two perpendicular axes.

An aspect of some embodiments of the current invention relates to a system of two cameras mounted at a fixed relation to each other on a swiveling frame. The frame optionally swivels around an axis. Optionally the 3 3D vectors defined by the two lines of sight of the two cameras and axis of swiveling fit into a single plane. In some embodiments, the system includes a processor configured to control the swiveling and/or the timing of picture taking by the cameras. For example, the processor may be configured to take pictures at multiple angles of swiveling. Optionally the system further includes an aerial platform and/or the frame is mounted on the aerial platform with the axis of swiveling parallel to a direction of flight of the platform. Optionally, the processor further controls the path of travel, for example to achieve a desired level of imaging coverage of area to capture images of every point in a region of interest at multiple angles from above and/or four directions and/or to map in three-dimensions the region and/or 3D features on the surface at a desired resolution from using an efficient flight path over the area in parallel flight lines.

### Exemplary Embodiments

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

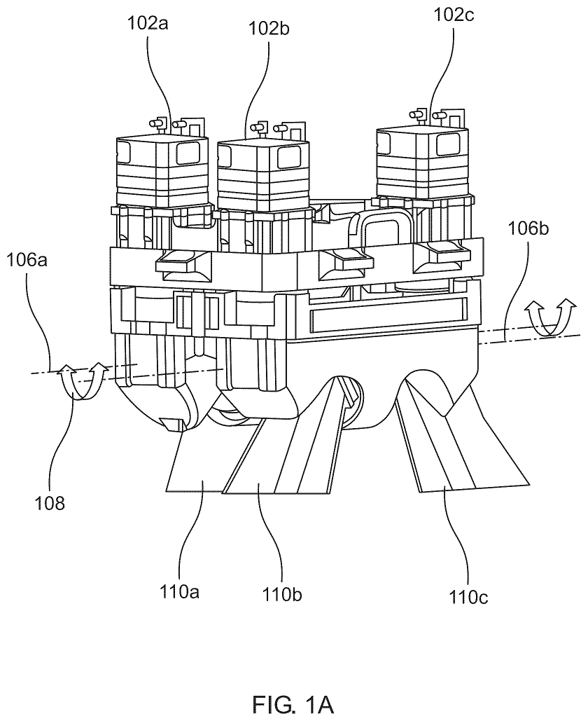

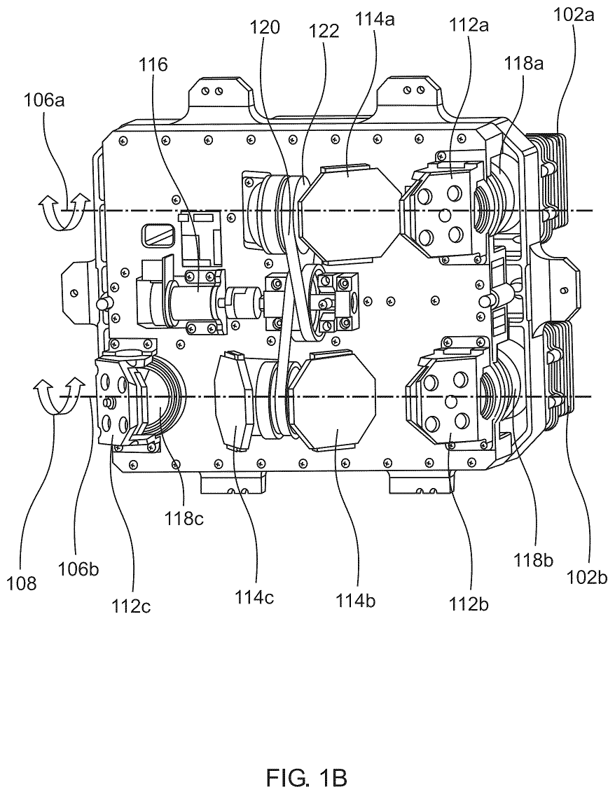

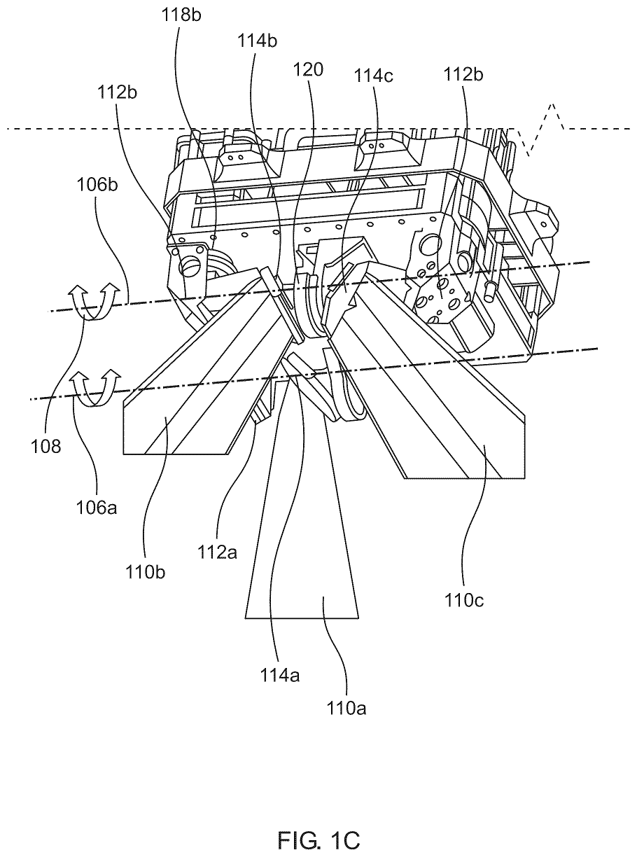

FIG. 1A is a schematic perspective view of a 3-camera embodiment in accordance with an embodiment of the current invention. In some embodiments, the device may be equipped with three cameras 102a-102c. For example, each camera 102a-102c may possess 120-megapixel resolution. Optionally, each camera 102a-102c may be able to capture 5 FPS. Two of the cameras 102b, 102c may be fitted with 300 mm high-resolution lenses. One of the cameras 102a may be fitted with a 180 mm lens. The device may be affixed to an airplane and/or a drone and/or another type of flying vehicle. The device may be affixed in a manner in which the cameras 102a-102c may face down. For example, the device may be mounted under a wing and/or under a fuselage and/or in the fuselage looking out a window in the fuselage.

Some embodiments of the current invention may include a mirror system. The mirror system may rotate and/or move in order to sweep (e.g., as illustrated by arrows 108) the FOV 110b, 110a of some or all of the cameras 102a-102c around one or more axes 106b, 106a. In some embodiments, the cameras 102a-102c may be stationary with respect to the aircraft. Optionally, mirrors may be placed side to side (e.g., perpendicular to an axis 106b, 106a of sweeping) and/or be aligned along an axis 106b, 106a of sweeping. The mirrors may direct the area being photographed into one or more of the lenses.

In some embodiments a mirrors may sweep the field of view a camera 102a-102c. For example, the FOV 110a camera 102a and/or of the lower (e.g., 180 mm) focal length lens may be directed by a mirror in a nadir range (e.g., directly downward) and/or swept by the mirror over a range of nadir angles (e.g., downward and swept over a range of lateral angles) around a longitudinal axis 106a. Additionally or alternatively, a mirror may be placed directing the FOV 110b one or more cameras 102b, 102c with a higher focal length lens (e.g., 300 mm). For example, the FOV 110b of one camera 102b may be directed and/or swept from side to side at a 30-degree angle forward around a longitudinal axis 106b. A second mirror may be placed directing the FOV 110c of the second oblique camera 102c (a second of the cameras with a higher 300 mm focal length lens) at a backward angle (e.g., 30-degree angle backward) around the axis 106b. The mirrors may move in a manner that provides the lens with a sweeping view of the area to be photographed (e.g., sweeping laterally). For example, the lenses may be rotated over an angle of ±45 (for example, the FOV of cameras pointed downward, forward and/or backward may be swept between across a range of lateral angles (e.g., over a range of less than 30 degrees and/or between 30 to 60 degrees or between 60 to 90 degrees to the axis 106b, 106a of sweeping [for example, the axis 106b, 106a of sweeping may be longitudinal]). For example, the FOV 110b, 110c may include pointing backward and/or forward and/or downward at an unchanging angle to the axis 106b, 106a of sweeping).

In some embodiments, taking images at a higher altitude may facilitate for a greater area to be photographed in a shorter time-frame than at a lower altitude. For example, it may be possible to photograph an area of 180 square kilometers for 4 cm 3D mapping in approximately one hour. Additionally, the higher altitude may reduce the effect on the mapping of height changes on the ground. In the embodiments, of FIG. 1A, the two oblique cameras 102b, 102c are positioned along a first axis 106b of sweeping while the nadir camera 102a is positioned beside one of the oblique cameras and/or its FOV 110a is swept around a second axis 106a.

FIG. 1B is a schematic bottom view of a 3-camera embodiment in accordance with an embodiment of the current invention. In some embodiments, a line-of-sight LoS of a camera is aligned to an axis of sweeping. For example, the LoS of the lens 118a-118c of the camera 102a-102c may be fixed at an angle to the axis 106a, 106b of sweeping and/or a fixed mirror 112a-112c may redirect the LoS of the camera onto the axis 106a, 106b of sweeping. For example, the LoS camera 102a may be oriented by a lens 118a from any angle (e.g., vertical) to parallel to and/or colinear to a horizontal axis 106a of sweeping (e.g., an axis 106a of sweeping parallel to the LoF of the aircraft) for example, a fixed mirror 112a may be mounted (e.g., at 45 degrees) to redirect the LoS of camera 102a and/or lens 118a. Optionally, a rotating mirror 114a then reflects the LoS to a FoV 110a of the camera 102a. For example, for a nadir camera 102a the rotating mirror 114a may be directed at an angle of 45 degrees to the axis 106a of sweeping (e.g., ranging between 40 to 50 degrees and/or ranging between 30 to 60 degrees). For example, for an oblique camera 102b a LoS of a lens 118b may be directed by a fixed mirror 112b along an axis 116b of rotation of a rotating mirror 114b. For example, the mirror 114b may be directed at an angle of 60 degrees to the axis 106b of sweeping (e.g., ranging between 50 to 70 degrees and/or ranging between 40 to 80 degrees). For example, for an oblique camera 102c a LoS of a lens 118c may be directed along an axis 106b of rotation by fixed mirror 112b and/or the FOV 110c may be directed by a rotating mirror 114c at an angle of 30 degrees to the axis of sweeping (e.g., ranging between 20 to 40 degrees and/or ranging between 10 to 50 degrees). For example, the mirrors 114a, 114b, 114c may rotate to direct the FoV 110a, 110b, 110c laterally (sideways) with respect to the axis 106a, 106b of sweeping. For example, defining 0 degrees as parallel to the axis 106a, 106b of sweeping (e.g., directly forward and downward or directly backward and downward for the oblique camera 102b, 102c and/or directly downward for the nadir camera 102a [perpendicular to the axis of sweeping]) the mirrors 114a-114c may be swept between by rotating the mirrors 114a-114c around the axis 106a, 106b, 106c of sweeping ranging between +45 degrees to −45 degrees and/or between +30 degrees to −30 degrees and/or between +15 degrees to −15 degrees.

In some embodiments, some or all of the cameras 102a-102c are mounted with a line of sight of the camera 102a-102c at an angle to the axis 106a, 106b of rotation of the mirrors 114a-114b, for example, perpendicular to the axis and/or at an angle of between 60 to 90 degrees and/or between 30 to 60 degrees and/or between 5 to 30 degrees. Optionally, a stationary mirror 112a-112c directs the line of sight of the camera 102a-102c towards the rotating mirror 114a-114c. Optionally, the stationary mirror 112a-112c directs the line of sight of the camera parallel to and/or along the axis 106a, 106b of rotation of the mirror.

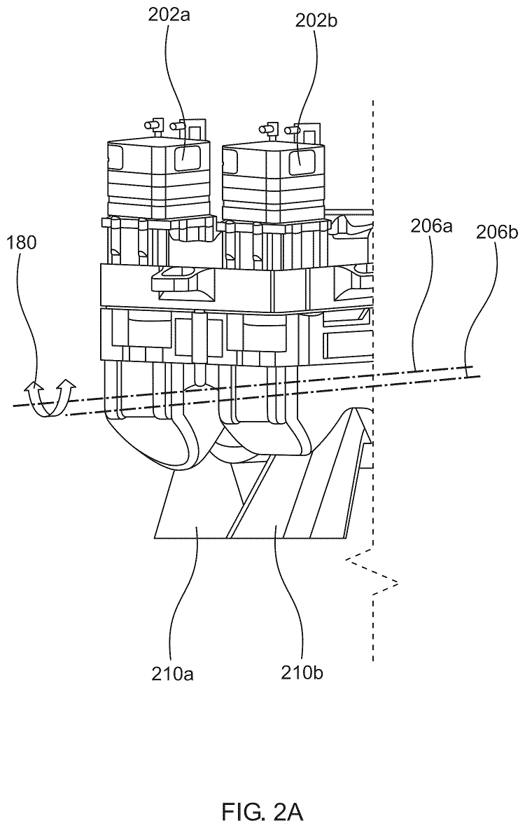

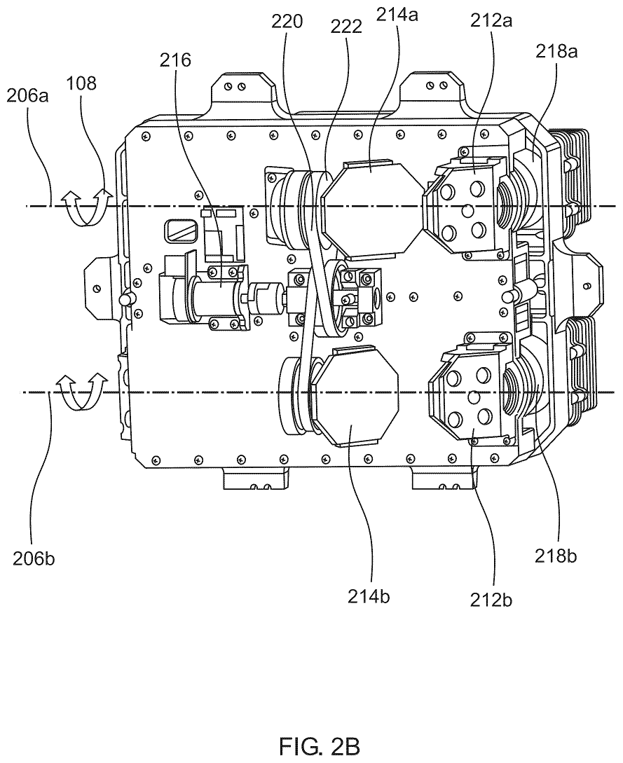

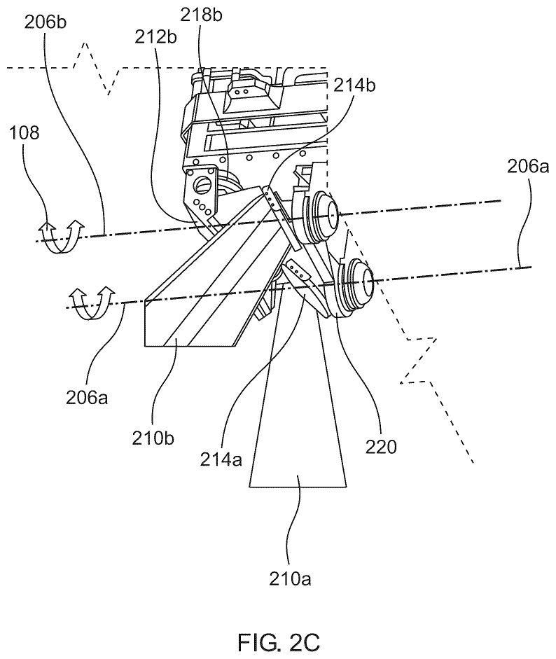

One actuator 116 may drive one or more bands 120 and/or drive wheels 122 in a synchronized manner. Optionally each band 120 and/or drive wheel 122 rotates one or more shafts and/or mirrors 114a-114c. For example, in the embodiment of FIG. 2a one actuator 116 drives two bands 120, each band driving a drive wheel 122 driving a separate axle. One axle rotates a nadir mirror 114a and the other axle rotates two oblique mirrors 114b, 114c (e.g., facing in opposite directions with respect to the axis of rotation 106b e.g., one facing forward and the other facing backward). Optionally, the bands 120 are low elasticity and/or low recoil (e.g., metal and/or Kevlar and/or carbon fiber bands). Optionally, the connection between the bands 120 and the drive wheels 122 is low slip (for example, a permanent connection may allow movement over an angle of less than 90 degrees and/or less than 70 degrees and/or less than 50 degrees and/or less than 30 degrees and/or less than 15 degrees). Optionally movement of the FoV's 110a-110c of all of the cameras 102a-102c are synchronized.

FIG. 1C is a bottom perspective view of a 3-camera system in accordance with an embodiment of the current invention. In some embodiments, a single axle may hold one or more nadir and/or oblique mirrors. For example, mirrors 114b and 114c are mounted and/or rotated coaxially, collinearly and/or simultaneously. For example, mirrors 114b and 114c are mounted to a single axle. Optionally, mirrors 114b and 114c are directed in opposite longitudinal directions (e.g., along their joint axis 106b of rotation). Additionally or alternatively, mirrors (e.g., mirrors 114a and 114b) may rotate on different axes 106a and 106b. Optionally, rotation of the mirrors 114a and 114b may be synchronized, for example, by connecting bands, for example low recoil bands 120. Optionally, mirrors 114a and 114b rotate around parallel axes 106a and 106b.

FIG. 2A is a schematic perspective view of a 2-camera embodiment in accordance with an embodiment of the current invention. In some embodiments, the device may be equipped with two cameras 202a, 202b. For example, each camera 202a, 202b may possess 120-megapixel resolution. Optionally, each camera 202a, 202b may be able to capture 5 FPS. For example, a second camera 202b may be fitted with a 300 mm high-resolution lens. One camera 202a may be fitted with a 180 mm lens.

In some embodiments, the device may be affixed to an airplane and/or a drone and/or another type of flying vehicle. Optionally, the device may be affixed in a manner in which the cameras 102a, 102b may face downward. Some embodiments of the current invention may include a system of mirrors. The mirrors may rotate and/or move in order to sweep a FOV 210a of camera 102a and/or a FOV 210b of camera 202b. For example, the cameras 202a, 202b may be stationary with respect to the aircraft. For example, the mirrors may sweep the FOV's 210a, 210b of the cameras 202a, 202b around an axis 206a, 206b that is horizontal and/or parallel to a flight path of the aircraft and/or aligned with a line of flight of the aircraft. Optionally, the mirrors may be placed side to side (e.g., on two separate axes 206a, 206b of rotation). Alternatively or additionally, mirrors be aligned along an axis of sweeping.

In some embodiments, mirrors may direct the FOV 210a, 210b being photographed of one or more cameras 202a, 202b and/or lenses. In some embodiments one of the mirrors may sweep the FOV 210a, 210b of the camera 202a, 202b. For example, the FOV 210a of the lower (180 mm) focal length lens may be directed in a nadir range (e.g., directly downward). A second mirror may be placed directing the FOV 201b of the oblique camera 202b (e.g., the cameras 202b with a higher 300 mm focal length lens) at a 30-degree angle forward. The mirrors may move in a manner that provides the lens with a sweeping view of the area to be photographed. For example, the lenses may be rotated over an angle of ±45 (for example, the FOV may be swept between pointed downward, forward and/or backward at an angle (e.g., 60 degrees or 90 degrees to the axis of sweeping) to pointing rightward and/or leftward and/or forward and/or downward at the same angle to the axis of sweeping).

In some embodiments, the area being mapped may be photographed from a higher altitude. For example, photographing from a higher altitude may allow for a greater area to be photographed in a shorter time-frame. For example, it may be possible to photograph an area of 180 square kilometers for 4 cm 3D mapping in approximately one hour. Additionally, the higher altitude may reduce the effect on the mapping of height changes on the ground. In the embodiment of FIG. 1B the two cameras are positioned side to side.

In some embodiments, a system with two cameras 202a, 202b traveling on a single line of flight may photograph the region in 6 of nine views. For example, the first camera 202a may take nadir images which are swept over a range including a range from three views, direct downward, downward left and downward right. For example, the second camera may oblique images in one longitudinal direction (e.g., either forward or backward) swept over a range of three views (e.g., directly forward and downward, forward downward and left, and forward downward and right). By traveling on parallel flight paths in opposite directions the oblique camera 202b may complete the oblique views to make a full set of 9 views. For example, traveling along a first line of flight in a northward direction the camera 202a may be nadir images left down and right while the oblique camera 202b may make oblique images in the North, North East, Northwest directions. On a parallel path in the opposite direction (e.g., Southward) the camera 202a may be nadir images left down and right while the oblique camera 202b may make complete the set of six oblique view and/or 9 total views by taking oblique images in the South, South East, Southwest directions. (thus, of full set of 9 views is created including three nadir views downward, downward East and downward West and six oblique views North, North East, Northwest, South, South East, and Southwest.

FIG. 2B is a schematic bottom view of a 2-camera embodiment in accordance with an embodiment of the current invention. In some embodiments, a Line of Sight a camera 202a, 202b is aligned to an axis of sweeping 206a, 206b. For example, the line of sight of the lens 218a, 218b of the camera 202a, 202b may be fixed at an angle to the axis 206a, 206b of sweeping and/or a fixed mirror 212a, 212b may redirect the LoS of the camera onto the axis 206a, 206b of sweeping. For example, the camera 202a, 202b and/or lens 218a, 218b may be vertically oriented and/or the fixed mirror 212a, 212b may be mounted at 45 degrees to redirect the LoS along a horizontal axis 206a, 206b of sweeping (e.g., an axis 206a, 206b of sweeping parallel to the LoF of the aircraft).

In some embodiments, a rotating mirror 214a, 214b then reflects the FoV of the camera. For example, for a nadir camera 202a the rotating mirror 212a may be directed at an angle of 45 degrees to the axis 206a of sweeping (e.g., ranging between 40 to 50 degrees and/or ranging between 30 to 60 degrees). For example, for an oblique camera 202b the rotating mirror 214b may be directed at an angle of 60 degrees to the sweeping axis 206b (e.g., ranging between 50 to 70 degrees and/or ranging between 40 to 80 degrees). For example, the mirrors may rotate to direct the FoV 210a, 210b sideways with respect to the axis of sweeping. For example, defining 0 degrees as parallel to the axis of sweeping (e.g., directly forward and downward or directly backward and downward for the oblique camera and/or directly downward for the nadir camera [perpendicular to the axis of sweeping]) the mirrors 214a, 214b may be swept between by rotating the mirrors around the axis of sweeping between +45 degrees to −45 degrees.

In some embodiments, some or all of the cameras 202a, 202b are mounted with a line of sight of the camera 202a, 202b an angle to the axis 206a, 206b of rotation of the mirrors 214a, 214b. For example, perpendicular to the axis 206a, 206b and/or at an angle of between 60 to 90 degrees and/or between 30 to 60 degrees and/or between 5 to 30 degrees. Optionally, a stationary mirror 212a, 212b directs the line of sight of the camera 202a, 202b towards the rotating mirror 214a, 214b. Optionally, the stationary mirror 212a, 212b directs the line of sight of the camera 202a, 202b parallel to and/or along the axis 206a, 206b of rotation of the mirror 214a, 214b.

In some embodiments a single actuator 216 may drive rotation of multiple mirrors 214a, 214b. For example, one or more bands 220 and/or one or more drive wheels 222 may connect the actuator 216 to multiple mirrors 214a, 214b in a synchronized manner. Optionally each band 220 and/or drive wheel 222 rotates one or more shafts and/or mirrors 214a, 214b. For example, in the embodiment of FIG. 2a one actuator 216 drives two bands 220, each band driving a separate axle and/or mirror 214a, 214b. For example, one axle rotates a nadir mirror 214a and the other axle rotates an oblique mirror 214b. Alternatively or additionally, the actuator may be directly connected to one axle and/or mirror while a band interconnects the mirrors and/or drives movement of the other mirror. Optionally, the bands 220 are low elasticity and/or low rebound (e.g., metal, Kevlar and/or carbon fiber bands). Optionally, the connection between the bands 220 and the drive wheels 222 is low slip (for example, a permanent connection may allow movement over an angle of 90 degrees and/or 70 degrees and/or 50 degrees and/or 30 degrees and/or 15 degrees). Optionally movement of the FoV's 210a, 210b of all of the cameras are synchronized. Alternatively or additionally, the actuator may drive one axle that holds a nadir mirror and/or an oblique mirror. For example, each mirror may be on an end of the axle and/or be directed in a different (e.g., opposite direction). For example, the LoS's of the two cameras may be directed along the axis of sweeping from opposite directions (for example like to the two oblique cameras of FIG. 2A and/or as illustrated in for a case of one oblique camera and one nadir camera in FIG. 3C.

FIG. 2C is a bottom perspective view of a side by side 2 camera system in accordance with an embodiment of the current invention.

FIG. 3 is a bottom perspective view of an axially aligned 2 camera system in accordance with an embodiment of the current invention. One actuator may drive a two mirrors 314a, 314b rotating around a single axis 306. For example, the rotation may be driven by a single axle band and/or drive wheel and/or the actuator may directly drive the axle. Multiple mirrors 314a, 314b mounted on the axle may rotate in a synchronized manner. For example, one axle rotates a nadir mirror 314a and an oblique mirror 314b. Optionally, in a case where there is a band between the motor and the axle it may include a low elasticity and/or low recoil band (e.g., metal, Kevlar and/or carbon fiber bands). Optionally, the connection between the band and the drive wheel is low slip (for example, a permanent connection may allow movement over an angle of 90 degrees and/or 70 degrees and/or 50 degrees and/or 30 degrees and/or 15 degrees). Optionally movement of the FoV's 310a, 310b of all of the cameras are synchronized. For example, each mirror 314a, 314b may be on an end of the axle and/or be directed in a different (e.g., opposite direction). For example, the LoS's of the two cameras may be directed along the axis of sweeping from opposite directions.

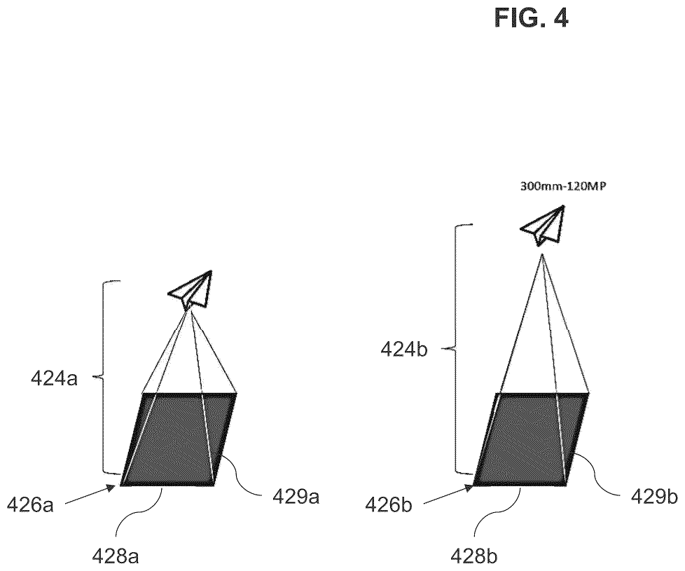

FIG. 4 illustrates comparable resolution for nadir photographs at different altitudes using different lenses in accordance with an embodiment of the current invention. For example, a photo 426a taken at 560 meters altitude 424a with a nadir camera facing directly downward with a 70 mm lens will cover an area of width 428a approximately 320 m and length 429a approximately 426 m. a nadir camera at 2610 meters altitude 424b with a 300 mm lens. In some embodiments, a precision map is produced with ground resolution for example of approximately 1 cm using a 150 MP nadir camera. A similar resolution can be achieved by photo 426b a 120 MP camera with a 300 mm lens at an altitude 424b of 2600 m. For example, the area of the photo 426b is approximately 290 m width 428b by 380 m length 429b and the ground resolution is also approximately 3 cm.

Similarly, for an oblique photograph (for example, at a 45-degree angle) For low altitude (e.g., 600 m altitude with a 70 mm focal length), for example a typical angular range of the lens may be 22 degrees vertical by 34 degrees horizontal. The length of the line from the camera to the ground at the center of the picture is sqrt(2)*600 and the width of the FOV is approximately 2*sin(34/2)*600*sqrt(2)=950 m. The length of the field of view would be 600*(tan(45+(22/2))−tan(45−(22/2)))=500 m. For a 150 MP sensor with the number of pixels in the longitudinal and lateral directions may be approximately sqrt(150,000,000)=12250 and the lateral resolution approximately 95000 cm/12250=8 cm while the longitudinal resolution may be approximately 50000 cm/12250=4 cm

For the high altitude case (e.g., 3000 m with a 300 mm focal length lens) an exemplary angular range of the lens may be 3 degrees vertical and 5 degrees horizontal. The length of the line from the camera to the ground at the center of the picture is sqrt(2)*600 and the width of the FOV is approximately 2*sin(5/2)*3000*sqrt(2)=315 m. The length of the field of view would be 3000*(tan(45+(3/2))−tan(45−(3/2)))=370 m. For a 120 MP sensor with the number of pixels in the longitudinal and lateral directions may be approximately sqrt(120,000,000)=11000 and the lateral resolution approximately 31500 cm/11000=2.9 cm while the longitudinal resolution may be approximately 37000 cm/11000=3.4 cm. Thus, according simple calculations, the high altitude FOV remains approximately square with little parallax (e.g., the spreading horizontal and vertical are approximately equal and do not change over the FOV) and the low altitude FOV is stretched longitudinally.

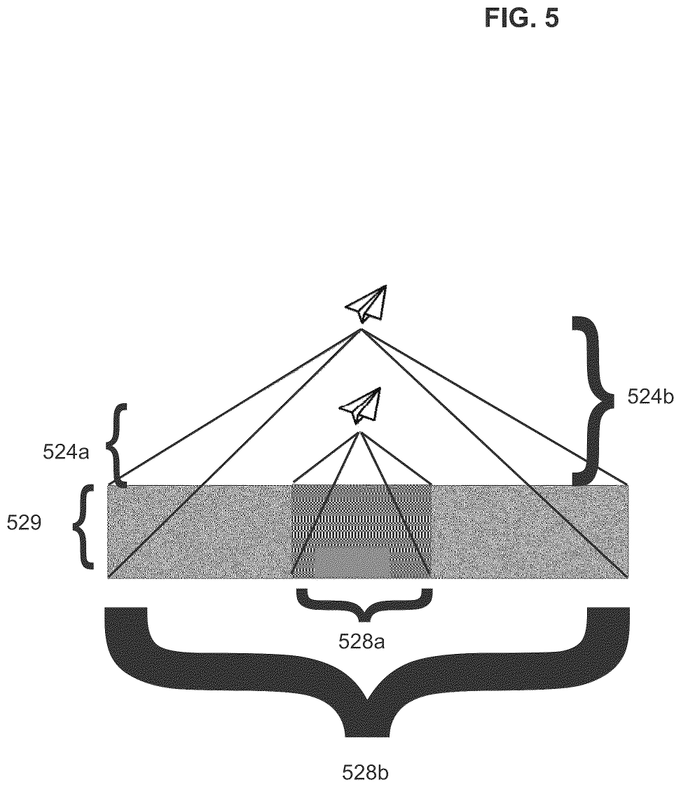

FIG. 5 illustrates comparable resolution for a 90-degree (from +45 to −45 around a longitudinal horizontal axis) sweep of oblique photographs (taken at and longitudinal angle of 45 degrees parallel to the axis) at different altitudes 524a, 524b using different lenses (e.g., at altitude 524a of 600 m using a 70 mm focal length lens and at and the advantage that is in accordance with an embodiment of the current invention. illustrates that although (e.g., as shown in FIG. 4) the precision and area of a single photo is similar for a photo taken at an altitude 524a of 600 meters with a 70 mm lens and a photo taken at an altitude 524b 3000 meters with a 300 mm lens. Nevertheless, when the cameras are swept over an area, the high-altitude 524b system (3000 meters with a 300 mm lens) captures considerably more area, facilitating mapping a larger area with the same number of passes. For example, while the longitudinal 529 dimension of the swept area is about the same for both cases, the lateral length 528a of the swept are is around 1100 m for the low altitude 524a case and the lateral length 528b is around 5000 m for the high-altitude 524b case.

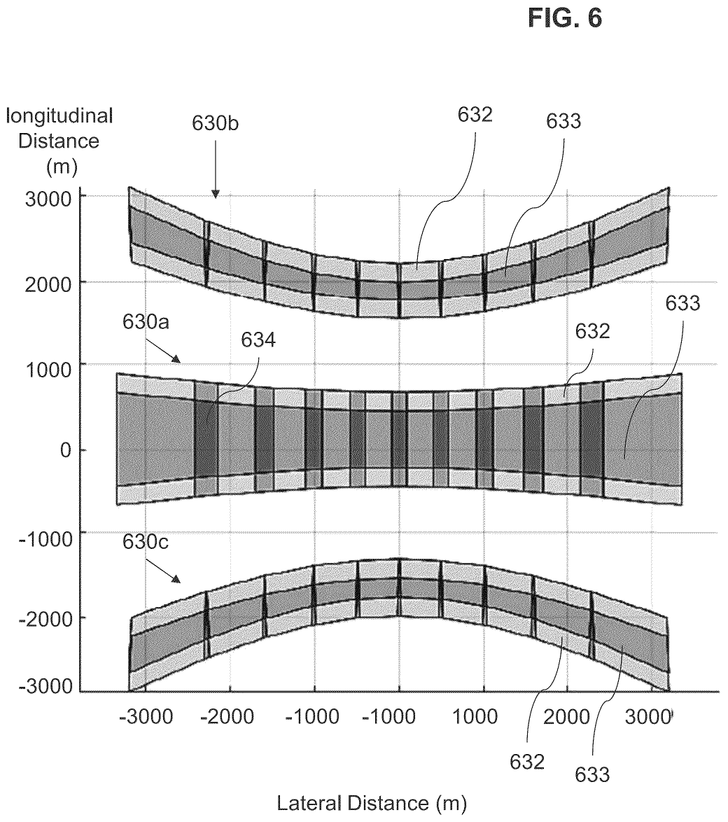

FIG. 6 illustrates the overlapping FOV's of 2 sweeps of a three-camera system while traveling on a single flight line in accordance with an embodiment of the current system. Illustrated are a two sweeps 630a of a nadir camera, two sweeps 630b of a forward oblique camera and two sweeps 630c of a rearward oblique camera. Light blocked areas 632 are areas covered by one image (e.g., the area 632 was in the field of view of one camera during one image in one sweep). Medium shaded areas 633 are areas covered by two images (e.g., either the area 633 was in the field of a camera during one image in each of two sweeps and/or was covered by two images in one sweep). Dark shaded areas 633 are areas covered by three images (e.g., the area 634 was in the field of one camera during two images in one sweep and one image of another sweep). In some embodiments, at the high-altitude parallax is reduced in comparison to lower altitude imaging allowing more images to be taken in a single sweep thereby covering more ground in each pass.

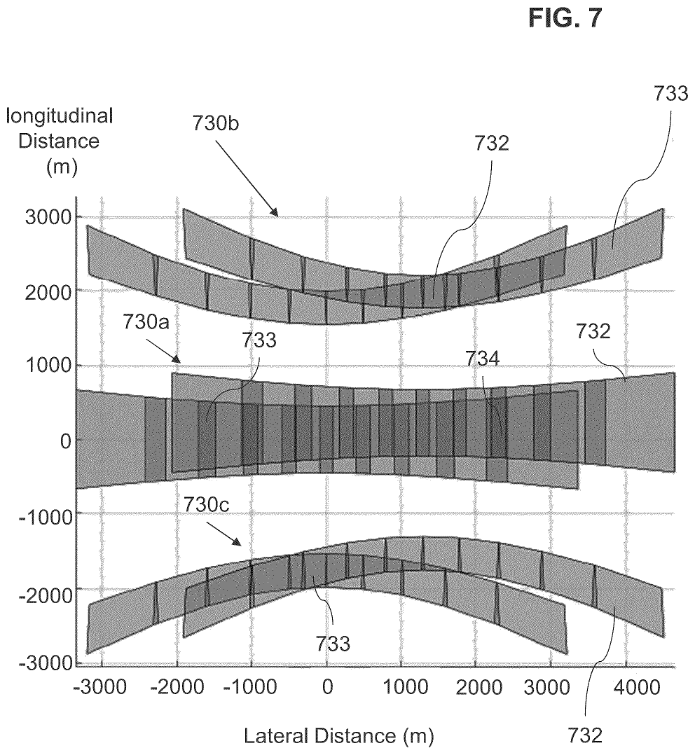

FIG. 7 illustrates the overlapping FOV's of overlapping sweeps of a three-camera system while traveling on two parallel flight lines in accordance with an embodiment of the current system. Illustrated are a two sweeps 730a of a nadir camera, two sweeps 730b of a forward oblique camera and two sweeps 730c of a rearward oblique camera (each sweep on a different parallel flight path). Light blocked areas 732 are areas covered by one image (e.g., the area 732 was in the field of view of one camera during one image in one sweep). Medium shaded areas 733 are areas covered by two images (e.g., either the area 733 was in the field of a camera during one image in each of two sweeps and/or was covered by two images in one sweep). Dark shaded areas 733 are areas covered by three images (e.g., the area 734 was in the field of one camera during two images in one sweep and another image in another sweep). In some embodiments, at the high-altitude parallax is reduced in comparison to lower altitude imaging allowing more images to be taken in a single sweep thereby covering more ground in each pass.

Optionally, when the system is mounted on an aircraft, a nadir camera is facing nadir (for example, in the in the lowest part of the sweep camera may be facing vertically downward from a horizontally directed aircraft). Additionally or alternatively, the second camera is an oblique camera that faces at a finite angle to axis of sweeping. For example, in the embodiment of FIGS. 1B, 2B 3B and 3C the oblique camera is directed at 30 degrees downward parallel to the axis of sweeping (e.g., the axis of sweeping is aligned to the direction of travel of the aircraft and/or an oblique camera is oriented facing 30 degrees forward and/or backward. Alternatively or additionally, a camera may be directed at an angle ranging, for example, between 30 to 50 degrees to the axis and/or between 10 to 30 degrees and/or between 60 to 80 degrees. Optionally, the sweeping axis may be mounted parallel to the longitudinal axis (roll axis) of the aircraft and/or the FoV of the oblique camera may be angled backwards and/or forward.

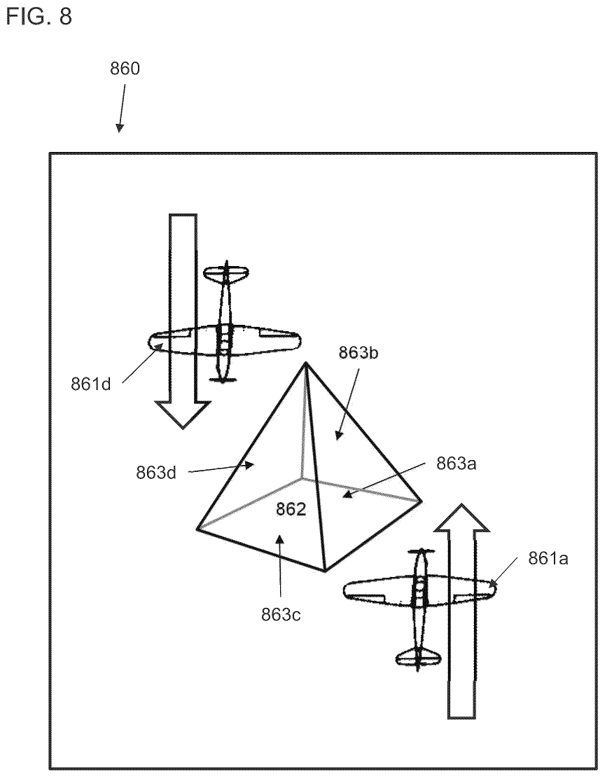

FIG. 8. schematically shows two LoF's 861a, 861d while surveying a region of interest 860. LoF 861a is flown first, while LoF 861d is subsequently flown. LoF's 861a, 861b are optionally parallel. Optionally an aircraft crosses a region a few times while surveying, but does not need to cross the same location twice. For example, an aircraft crosses a region in series of parallel lines, in opposite directions, but does not need to return over then same line twice and/or does not return over the same point twice (for example does not need a cross pattern where the plane crosses previous lines of flight).

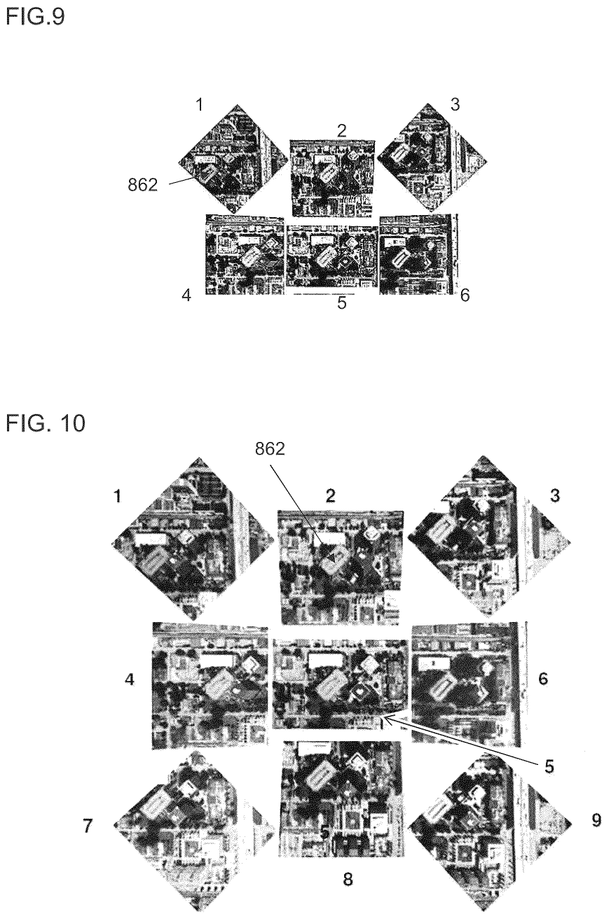

In some embodiments, the system only covers the nadir and forward views. Sweeping both cameras during a LoF in a single direction covers 3 oblique directions one side of the plane: (Right, forward, forward-right, and nadir) and/or 3 oblique directions on the opposite side of the plane: (Left, forward-left, and nadir) but not the three backward direction views. For example, while flying LoF 861a pictures will be taken of a front right face 863a of a building 862. In order to compensate that and to achieve 9 directions of view for each object in the region consecutive flight lines are optionally flown in opposite direction while the aircraft flies over the region on both sides of each feature. For example, in this embodiment, all 9 major views will be covered, using only two cameras. For example, face 863d is covered on LoF 861d. This will be further illustrated for example in FIGS. 9 and 10 and 13A-13D.

FIG. 9 schematically shows 5 different perspectives of oblique views obtained by a system in accordance with an embodiment of the current invention while traversing a LoF in one direction (i.e., LoF 861a heading “north”, as shown in FIG. 8). These views of are optionally achieved with the movement of two sweeping cameras, for example a forward camera and a nadir camera. For example, three forward images (images: #1 #2 #3), that are being collected by the forward facing camera, and one vertical image (#5), and two additional views to the sides of the vertical image (images #4 and #6), that are being collected by the nadir camera.

FIG. 10 schematically shows 9 different perspective views of objects on the ground obtained by a system in accordance with an embodiment of the current invention. After the completion of LoF 861d, which is flown to the opposite direction of LoF 861a (e.g., First LoF 861a is flown “Northward” and then the next LoF 861d is being flown “Southward”, as shown for example in FIG. 8), 9 directions of views are achieved.

In some embodiments, for example for a two-camera configuration with one camera nadir and one camera facing obliquely forward, to get all 9 views of any one object one would optionally pass back and forth in opposite direction on each of two sides of the objects. Alternatively or additionally, for an embodiment having at least one camera obliquely forward and one cameral obliquely backward (for example two oblique cameras and/or three cameras [two oblique and one nadir]) one would optionally cover all 9 views of an object passing once on one side and once on the opposite side. Either way, all 9 views of the zone would be achieved crossing the region on a back-and-forth flight path without crossing the same point more than once. E

FIG. 10 shows how 3 additional views (images #7, #8 and #9) are being collected by the forward camera when the aircraft passes over LoF 861d. Due to the 75% overlap between LoF's 861a and 861d, 8 oblique views (images #1, #2, #3, #4, #6, #8 and #9) are collected by cameras 1 and 2 in parallel, plus one vertical image (image #5) that is collected by camera #1. Optionally, overlap may range between 65% to 85% and/or 40% to 65% and/or between 10% to 40% and/or between 85% to 95%.

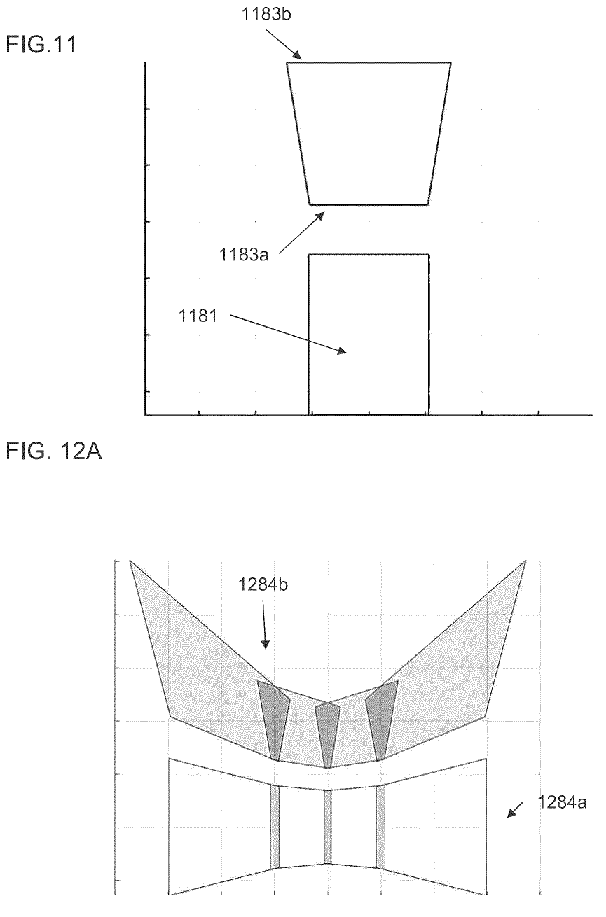

FIG. 11 schematically shows the coverage of a single image captured by each of the two cameras of a portion of the area of interest (one nadir and one in 45 degrees forward oblique). For example, using the dimensions and sensor size of two Cannon 5DSR cameras, 50 MP, with 50 mm focal length lens (for the nadir camera) and 85 mm focal length lens (for the forward oblique camera), a coverage of 100×100 M is achieved on the ground for the nadir view 1181. A ground resolution of 2 cm is achieved for Nadir and between 1.45 cm at the near end 1183a to 2 cm at the far end 1183b for the forward oblique view.

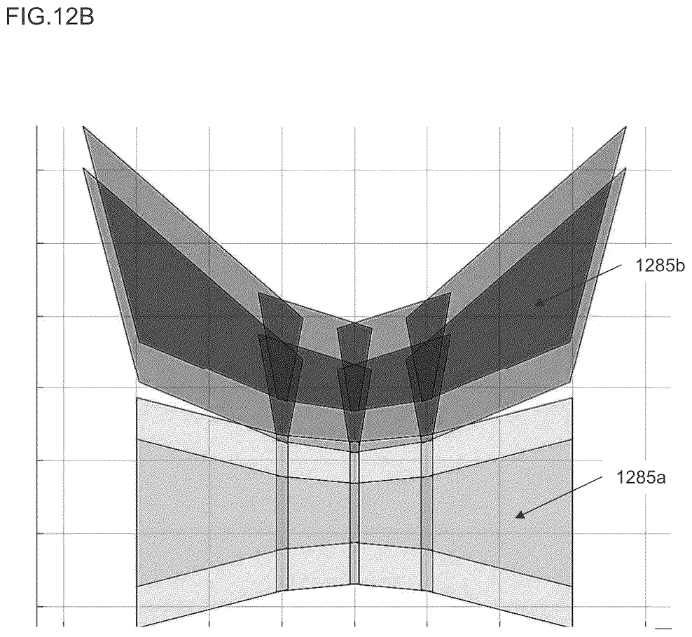

FIG. 12A displays a sweep containing 4 images 1248a for a nadir and 4 images 1248b for an oblique mounted camera in accordance with an embodiment of the current invention. Alternatively or additionally, a sweep may include between 2 to 4 images and/or between 4 to 8 images and/or between 8 to 20 images. With the same exemplary camera and lenses as described in the description of FIG. 11. The footprint coverage achieved on the ground is 734 M for the nadir. Optionally, there is an overlap 1284a and 1284b of 20% between the images 1248a, 1248b for the Nadir and oblique mounted cameras respectively in the sweep. Alternatively or additionally, an overlap within a sweep may range between 10% to 30% and/or 0 to 10% and/or 30% to 50% and/or 60% to 90%.

FIG. 12B schematically shows the respective coverage of two consecutive sweeps containing 4 images 1258a, 1258b each. There is 55% overlap between the sweeps of the nadir and obliquely mounted cameras respectively.

In an exemplary embodiment with the same cameras and lenses as described above with respect to FIGS. 11 and 12, coverage for example at 2 cm GSD (Ground Sample Distance) may include:
Foot print coverage: 734 m.
Distance between flight lines for orthophoto creation: 158 m.
Field of view: 113 degrees.
Views on an object: 9 different angles.

In some embodiments, the motor stops every 21 degrees to take one image inside a sweep. Alternatively or additionally, the stops may range between 15 to 25 degrees and/or between 5 to 15 degrees and/or between 25 to 45 degrees.

For example, the collective coverage may include:
Overlap between images in a sweep: 20%
Overlap between images between sweeps inside a single flight line: 55% Overlap between different flight lines: 75%
Flight lines collection sequence: fly adjacent flight lines in opposite directions.

In some embodiments, overlap between different flight lines may range for example, between 70 to 80% and/or between 50 to 70% and/or between 70 to 90% and/or between 20 to 50%.

For mission planning the system inputs for example Google earth KML file that bound the area of interest. The planning routine optionally automatically determines the flight lines according to input such as: lens focal length, flight altitude, terrain, speed of the aircraft, and/or resolution requirements. The planning file optionally includes the start point and/or end point of LoF so that it will provide coverage for the region of interest, for example as marked on Google earth. The automatic algorithm optionally calculates the required distances between lines, length of lines, flight altitude, and exact location of each line.

An example of a calculation to extract the flight management file and system activation during its performance could be:

Terms and Fixed Figures Used in the Calculation:
Camera—Canon 5DS-R with 50 mm lens (as described in the system)
Forward Overlap (%)=FO (55)
Side Overlap (%): SO (30)
Flying Speed (Knots): FS (90)
Maximal Angle for Ortho (Deg): MAO (18)
Focal length (mm): F (50)
Resolution Width (pixels): RW (8688)
Resolution Height (Pixels): RH (5792)
Pixel Size (mm): PS (0.00414)

Calculations:
Sensor Dimension X (mm) —SDX=RW*PS (36.0)
Sensor Dimension Y (mm) —SDY=RH*PS (24.0)
Field Of View X (deg): FOVX==39.60
Field Of View Y (deg): FOVY==26.99
Ground Sampling Distance: GSD (m)=GSD (0.1)

### Computations

Flying Altitude (m) —FA==(1206)
Image Coverage X (m) —ICX=RW*GSD=(868.8)
Image Coverage Y (m) —ICY=RH*GSD=(579.2)
Distance Between Frames (m) —DBFACX*(1−FO/100)=(390.96)
Distance Between Lines (m) (Without Sweeping) —ICY*(1−SO/100)=(405.44)
Time Between Frames (or “Cycle Time” in sweeping mode) —CT (sec)=(8.44)

### Sweeping

No. of Image In Sweep—NIS=(5)
In Sweep Overlap (%) —ISO=(20)
Sweep Angular Coverage—SAC=113.37
Sweep Step (deg) —SS=(21.59)
Sweep Coverage (m)==3671.50 Total Sweep Unique Pixels==24326.4
Tilt of first and last image in sweep=43.19
Distance Between Lines (m)=784.13

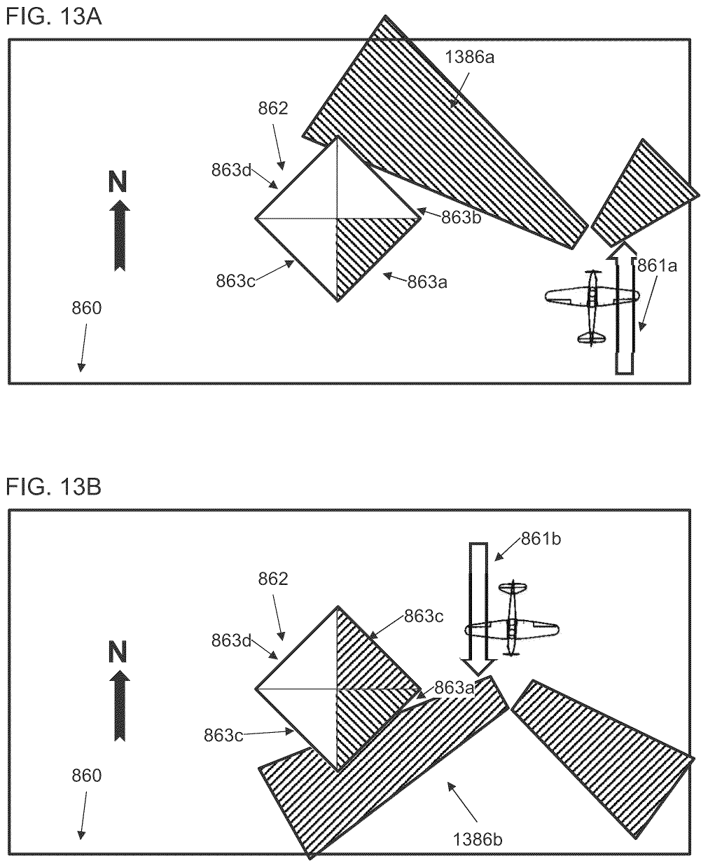

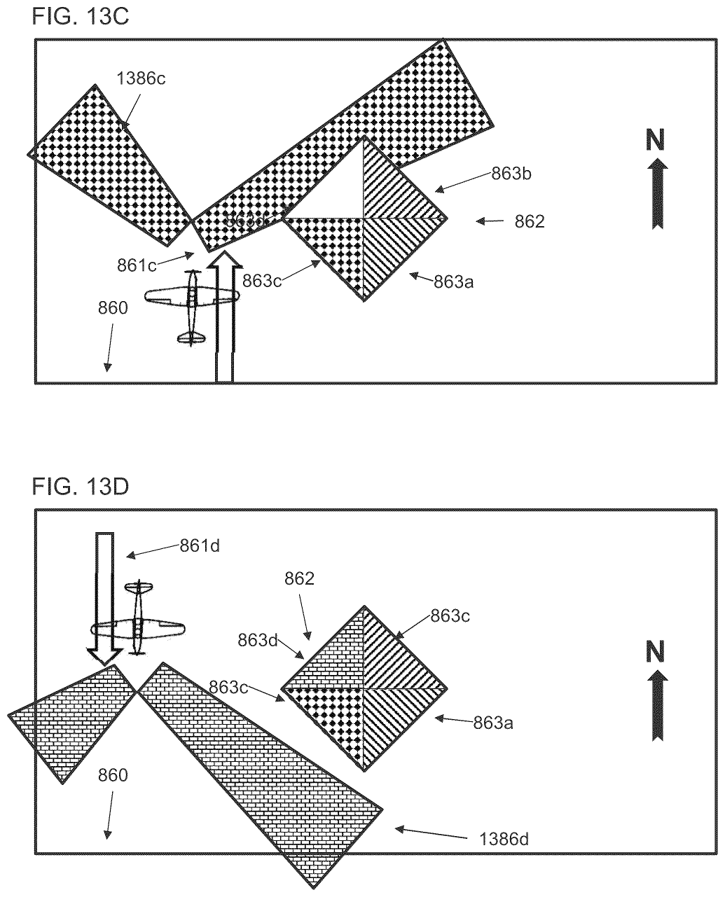

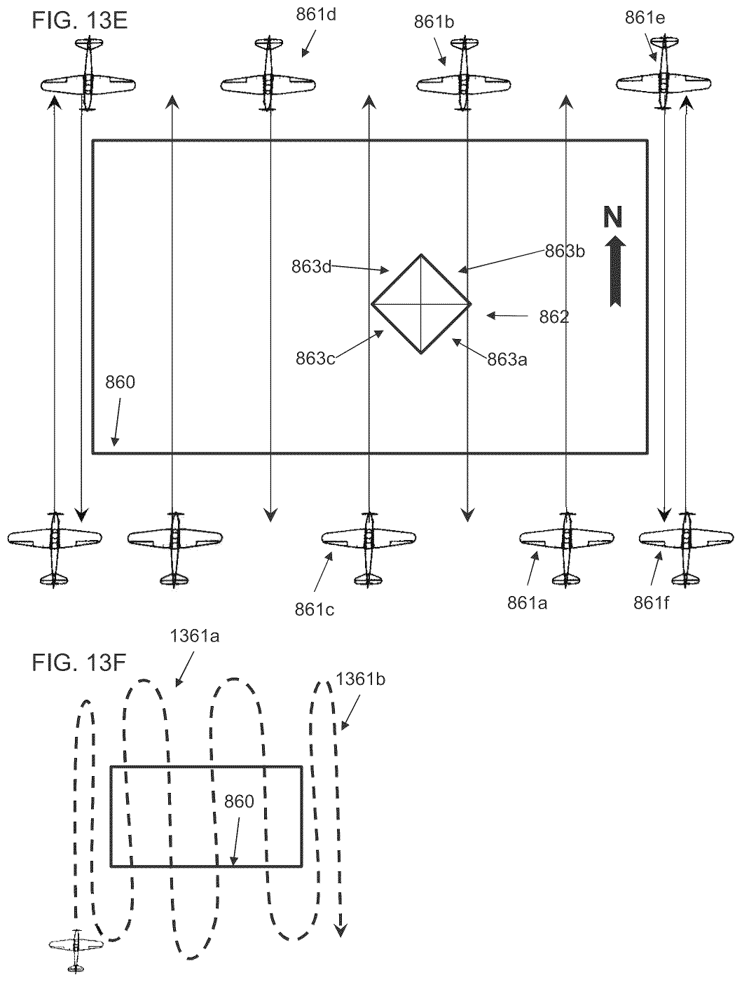

FIGS. 13A-13D are schematic illustrations of coverage various faces of a building 862 in four lines of flight in accordance with an embodiment of the current invention. In some embodiments all faces of an object may be imaged by passing the object on parallel LoF. For, example, in an embodiment with one oblique camera (for example forward) and one nadir camera, all 9 directions may be coved by four LoF. For example, one LoF in each of two opposite directions passing by each of two opposite sides of the object. Each of the four LoF's adds another face to the imaging collection.

For illustrative purposes building 862 is illustrated a s pyramid, dependent on the altitude and slope angle, a sloped face of a pyramid may be seen from the air even from opposite sides. The description herein may apply to for example to a rectangular building having vertical walls directed at 45 degrees to the LoF of the surveying aircraft and/or to surfaces on more complex structures that are oriented in various directions.

FIG. 13A illustrates passing building 862 on a first LoF 861a in a first direction. An oblique forward-facing camera captures a field of view FoV illustrated by 1386a. As the plane passes the East side of building 862, for example along a North-South LoF in a direction from South to North, with the oblique forward-facing camera taking overlapping pictures, the South-East face 863a will be imaged. On the other hand, faces which face North (e.g., face 863c) and/or West (e.g., 863c and 863d) may not get properly covered (e.g., images may not include these faces and/or the views of these faces may be at high angles wherein some features (e.g., sunken features and/or features angled away from the camera) will be hard to discern.

FIG. 13B illustrates passing building 862 on a second LoF 861b in on the same side as LoF 861a in an opposite direction. An oblique forward-facing camera captures a FoV illustrated by 1386b. As the plane passes the East side of building 862, for example along a North-South LoF in a direction from North to South with the oblique forward-facing camera taking overlapping pictures, the North-East face 863b will be imaged. On the other hand, faces which face South (e.g., face 863a) and/or West (e.g., 863c and 863d) may not get properly covered (e.g., images may not include these faces and/or the views of these faces may be at high angles wherein some features (e.g., sunken features and/or features angled away from the camera) will be hard to discern. For example, after passing in opposite directions on LoF's 1386a and 1386b faces 863a and 863b have been covered while faces 863c and 863d have not been properly covered.

FIG. 13C illustrates passing building 862 on a third LoF 861c in an opposite side thereof with respect to LoF's 861a and 861b and in the same direction as 861a. An oblique forward-facing camera captures a FoV illustrated by 1386b. As the plane passes the West side of building 862, for example along a North-South LoF in a direction from South to North with the oblique forward-facing camera taking overlapping pictures, the South-West face 863c will be imaged. On the other hand, faces which face North (e.g., face 863d) and/or East (e.g., 863a and 863b) may not get properly covered (e.g., images may not include these faces and/or the views of these faces may be at high angles wherein some features (e.g., sunken features and/or features angled away from the camera) will be hard to discern. For example, after three passes on LoF's 1386a, 1386b and 1386c faces 863a and 863b and 863c have been covered while face 863d has not been properly covered.

FIG. 13D illustrates passing building 862 on a fourth LoF 861d in on the same side as LoF 861c in an opposite direction. An oblique forward-facing camera captures a FoV illustrated by 1386d. As the plane passes the West side of building 862, for example along a North-South LoF in a direction from North to South with the oblique forward-facing camera taking overlapping pictures, the North-West face 863b will be imaged. On the other hand, faces which face South (e.g., face 863c) and/or East (e.g., 863a and 863b) may not get properly covered (e.g., images may not include these faces and/or the views of these faces may be at high angles wherein some features (e.g., sunken features and/or features angled away from the camera) will be hard to discern. For example, after passing building 862 on four LoF's 1386a and 1386b and 1386c and 1386d, faces 863a and 863b and 863c and 863d have all been properly covered.

FIG. 13E illustrates covering a RoI with multiple parallel LoF's on accordance with an embodiment of the current invention. Optionally an aircraft passes back and forth across a RoI 860 on parallel LoF's (e.g., LoF's 861a-861d). Additionally or alternatively, the aircraft may pass each side back and forth on parallel LoF's (e.g., LoF's 861e-861f). On each LoF the aircraft optionally covers objects on either side of the aircraft from one oblique point of view. For example, on one South to North directed path a forward pointing camera covers objects on the left side of the aircraft from the South East and/or objects on the right side of the aircraft from the South West. As the aircraft passes back from North to South a forward pointing camera covers objects on the left side of the aircraft from the North West and/or objects on the right side of the aircraft from the North East. Additionally or alternatively, a nadir mounted camera may catch view directly down and/or a side view (e.g., East and/or West). Optionally as the aircraft passes over the region on multiple passes, each object is photographed from all nine directions.

FIG. 13F illustrates covering a RoI 860 with a flight path 1361a, 1361b including multiple parallel LoF's on accordance with an embodiment of the current invention. A flight path 1361a may loop around back and forth across the RoI 860 on adjacent lines on each subsequent pass and/or the flight path may make larger loops skipping adjacent paths and/or filling in on subsequent passes. Optionally, path 1361a continues to path 1361b with at least two passes past a side of the RoI 860, for example to catch objects on near the edge of the RoI 860 from the that side.

FIG. 13G illustrates overlapping FoV's of an oblique forward-facing camera during multiple parallel LoF's on accordance with an embodiment of the current invention. Optionally, as an aircraft passes back on LoF's 861′ back and LoF's forth 861″, sweeps of an oblique (e.g., forward facing) camera 1386a-1386c and/or 1386a′-1386b′ overlap and capture all 9 views of each object in the RoI from multiple distances and/or angles.

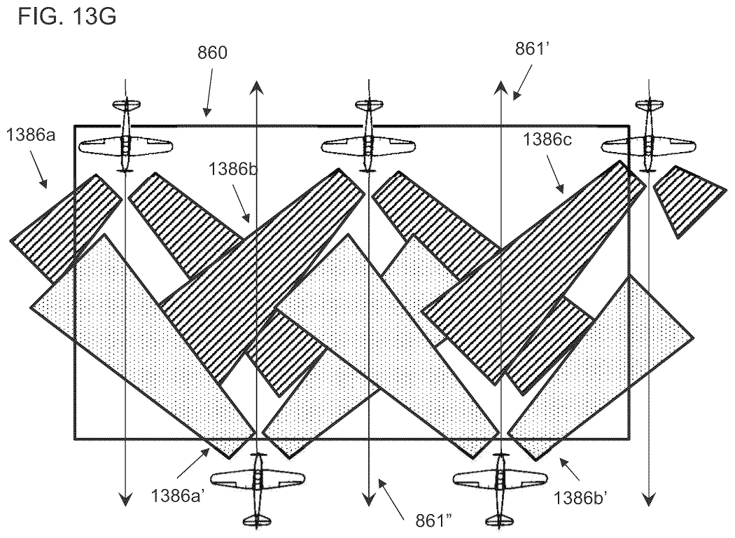

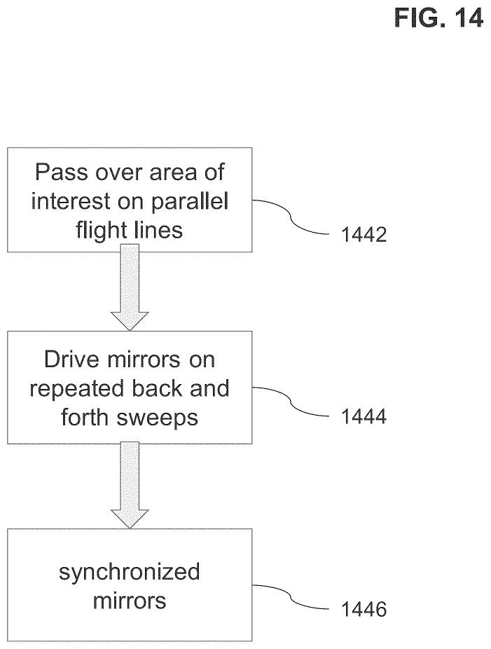

FIG. 14 is a flow chart illustration of a method of acquiring images for a 3D map. Optionally, two or more cameras are mounted with FoV's on an aircraft at different angles to an axis of rotation. For example, the axis of rotation may be the longitudinal axis of the plane and/or a line directed along of flight (LoF) of the aircraft. Optionally the LoF is horizontal (parallel to the ground). For example, one camera may be mounted with the FoV approximately perpendicular to the axis of rotation an and the second camera may be mounted at an oblique angle to the axis of rotation. Optionally, the fields of view FoV's of the cameras are swept laterally (e.g., transverse to the axis of rotation), for example by a set of mirrors. Optionally the FoV's of the cameras are synchronized 1446. For example, moving the mirrors of the two cameras may be mounted on the same axle and/or on different axles (optionally parallel axles) moved simultaneously and/or a rotating mirror may sweep the FoV's of two cameras together. Optionally, the sweeping is driven by an actuator driving 1444. For example, the axles may be synchronized by a low recoil and/or low slip band interconnecting the axles and/or connecting the axles to an actuator. For example, the sweeping may be in the plane formed by the lateral and vertical axes of the aircraft. For example, the sweeping may be on one or both sides of a downward direction (e.g., either vertically downward with respect to the ground and/or a vertical axis of the plane (perpendicular to the longitudinal axis of the plane)). Optionally while sweeping the cameras will take images and/or particularly the camera with FoV perpendicular to the axis of sweeping will capture images at various lateral angles of a region and/or the camera that has a FoV oblique to axis of sweeping will capture images of a first side of the scene over a first leg of the flight. Optionally the aircraft will pass back in an opposite (and/or if not directly opposite at least opposing) direction.

In some embodiments, the aircraft will pass 1442 over the region on parallel lines of flight. For example, a first LoF is flown first and a second LoF is subsequently flown. Optionally, each LoF is parallel to and/or in an opposite direction to the previous LoF. The LoF's are optionally parallel. Optionally an aircraft crosses a region a few times while surveying without to crossing the same location twice. For example, an aircraft crosses a region in series of parallel lines, in opposite directions. For example, the aircraft does not return over then same line twice and/or does not return over the same point twice (for example does not perform a cross pattern where the plane crosses previous lines of flight).

In some embodiments, a two-camera system only covers the nadir and forward views. Sweeping both cameras during a LoF in a single direction covers 3 oblique directions one side of the plane: (Right, forward, forward-right, and nadir) and/or 3 oblique directions on the opposite side of the plane: (Left, forward-left, and nadir) but not the three backward direction views. For example, while flying a first LoF pictures will be taken of a front right face of a building. In order to compensate that and to achieve 9 directions of view for each object in the region consecutive flight lines are optionally flown in opposite direction while the aircraft flies over the region on both sides of each feature. For example, in this embodiment, all 9 major views will be covered, using only two cameras. For example, one face is covered on the first LoF and the opposite face is covered on the next LoF in the opposite direction.

In some embodiments, 9 different perspective views of objects on the ground obtained by a system in accordance with an embodiment of the current invention. After the completion of a first LoF, a second LoF is flown to the opposite direction of the first LoF (e.g., First LoF is flown “Northward” and then the next LoF is being flown “Southward”), 9 directions of views are achieved.

In some embodiments, for example for a two-camera configuration with one camera nadir and one camera facing obliquely forward, to get all 9 views of any one object one would optionally pass back and forth in opposite direction on each of two sides of the objects. Alternatively or additionally, for an embodiment having at least one camera obliquely forward and one cameral obliquely backward (for example two oblique cameras and/or three cameras [two oblique and one nadir]) one would optionally cover all 9 views of an object passing once on one side and once on the opposite side. Either way, all 9 views of the zone would be achieved crossing the region on a back-and-forth flight path without crossing the same point more than once.

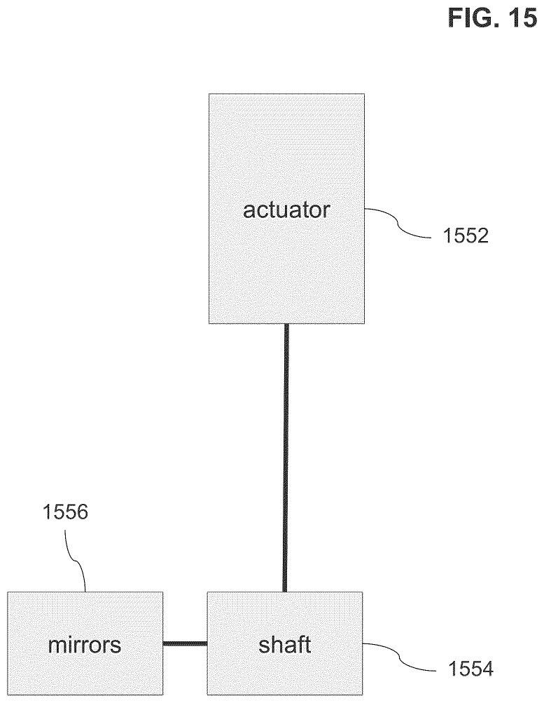

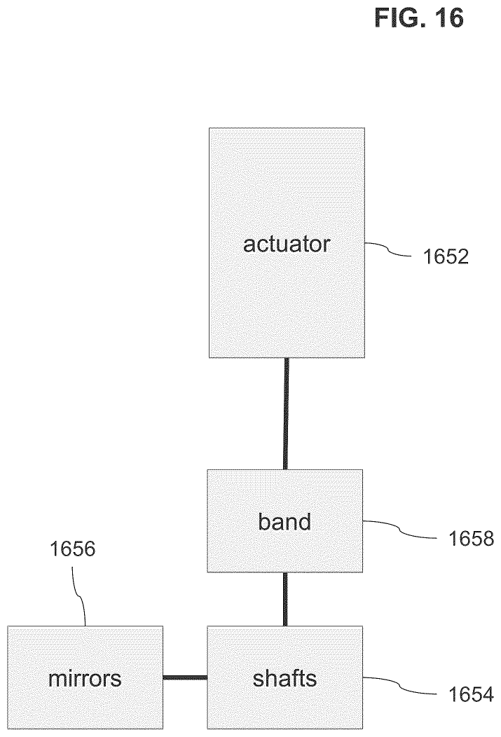

FIGS. 15 and 16 are block diagram of embodiments of the present invention. Two three or more cameras may be mounted to the mounting device. Each camera may possess the appropriate lens, described above. The mirrors may be attached to a rotation device at the appropriate angles, described above. The rotation device may be attached to the mounting device. The mounting device itself may be attached to the airplane and/or drone. The mirrors and cameras may be side by side and/or coaxial.

In some embodiments, an actuator 1552 may drive a shaft 1554. For example, the shaft 1554 may be rotate over a range of angles (for example, over less than 30 degrees and/or between 30 to 60 degrees and/or between 60 and 90 degrees). Optionally, a plurality of mirrors 1556 are attached to the shaft 1554. For example, the shaft may be mounted longitudinally to an aircraft. For example, one or more of the mirrors 1556 may direct a FoV of one or more cameras in a Nadir direction (e.g., perpendicular to the shaft 1554) and/or an oblique direction (e.g., at an angle less than 30 degrees to the shaft and/or at an angle of between 30 to 60 degrees to the shaft). Optionally, rotating the shaft 1554 rotates the plurality of mirrors 1156 in a synchronized manner. For example, each of the mirrors 1556 may direct a FoV of a corresponding camera at the same angle as one or more other of the cameras and/or mirrors 1556 at the same time. For example, a shaft may include an oblique mirror and a nadir mirror (e.g., mirrors 314a and 314b of FIG. 3) and/or two oblique mirrors (e.g., facing in opposite oblique directions e.g., as illustrated in mirrors 114a and 114b of FIGS. 1B and 1C). Optionally, the actuator 1552 may drive the shaft 1554 directly and/or via a transmission (e.g., a low recoil rive belt and/or a gear and/or another system).

In some embodiments, an actuator 1652 may drive multiple shafts 1654. For example, each shaft 1554 may be rotate over a range of angles (for example, over less than 30 degrees and/or between 30 to 60 degrees and/or between 60 and 90 degrees). Optionally, a one or more mirrors 1656 is attached to each shaft 1654. For example, the shafts 1654 may be parallel and/or may be mounted longitudinally to an aircraft. For example, one or more of the mirrors 1656 may direct a FoV of one or more cameras in a Nadir direction (e.g., perpendicular to one of the shafts 1654) and/or an oblique direction (e.g., at an angle less than 30 degrees to one the shafts 1654 and/or at an angle of between 30 to 60 degrees to one of the shafts 1654). Optionally, rotating the shafts 1654 rotates the plurality of mirrors 1656 in a synchronized manner (for example, a band interconnects drive wheels. For example, each of the mirrors 1656 may direct a FoV of a corresponding camera at the same angle as one or more other of the cameras and/or mirrors 1656 at the same time. For example, the shafts 1654 may include an oblique mirror and a nadir mirror (e.g., mirrors 214a and 214b of FIGS. 2B and 2C) and/or a nadir mirror and two oblique mirrors (e.g., facing in opposite oblique directions e.g., as illustrated in mirrors 114a-144c of FIGS. 1B and 1C).

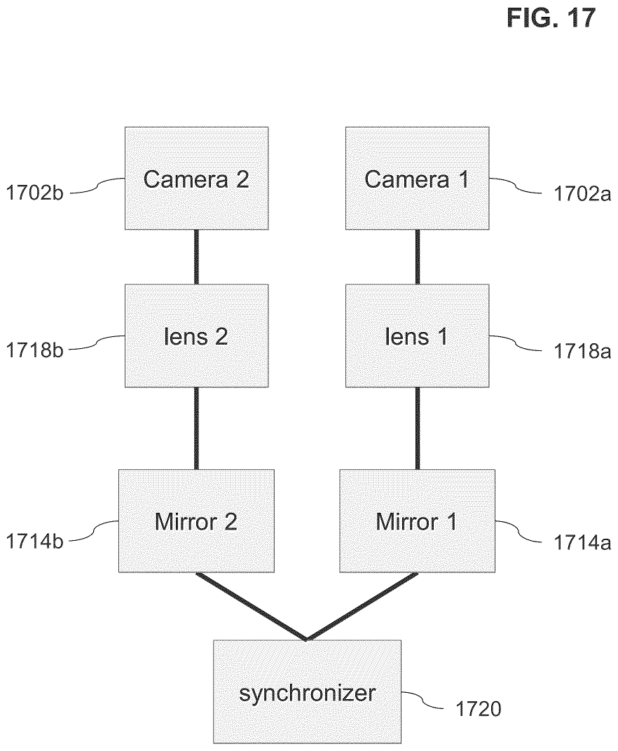

FIG. 17 is a block diagram illustrating a system for aerial mapping in accordance with an embodiment of the current invention. In some embodiments, a system for three-dimensional mapping may include a first camera 1702a imaging through a first lens 1718a of for example 180 mm focal length. For example, the first camera 1702a is used for taking nadir images.

In some embodiments, a second camera 1702b images through a second lens 1718b of, for example, 300 mm focal length. Optionally, the focal length of said second lens is greater than a focal length of said second lens 1718b. For example, the second camera 1702b is used for taking oblique images.

In some embodiments a sweeping system may sweep the fields of view of the first camera 1702a and the second camera 1702b. For example, the sweeping system may include a first mirror 1714a. The line of sight of the first camera 1702a may be directed at the first mirror 1714a. For example, the first mirror 1714a may reflect the field of view of the first camera 1702a downward (e.g., perpendicular to an axis of sweeping which is optionally horizontal to the ground and/or along a LoF of the aircraft and/or along a longitudinal axis of the aircraft). Optionally, the sweeping system may sweep the angle of the first mirror 1714a over a range from, for example, +40 degrees laterally to −40 degree laterally. For example, the sweeping system may sweep the field in a direction ranging between 80 to 90 degrees around an axis of sweeping and/or between 30 to 80 degrees around the axis of sweeping and/or around 10 to 30 degrees around the axis of sweeping. For example, the sweeping system may include a second mirror 1714b. The line of sight of the second camera 1702b may be directed at the second mirror 1714b. For example, the second mirror 1714b may reflect the field of view of the second camera 1702b obliquely (e.g., as an angle of between 0 to 10 and/or 10 to 30 and/or 30 to 60 degrees of to an axis of sweeping which is optionally horizontal to the ground and/or along a LoF of the aircraft and/or along a longitudinal axis of the aircraft). Optionally, the sweeping system may sweep the angle of the second mirror 1714b over a range from, for example, +40 degrees laterally to −40 degree laterally. For example, the sweeping system may sweep the field in a direction ranging between 80 to 90 degrees around an axis of sweeping and/or between 30 to 80 degrees around the axis of sweeping and/or around 10 to 30 degrees around the axis of sweeping. Optionally, the axis of sweeping of the first mirror 1714a and second mirror 1714b are colinear and/or parallel.

In some embodiments, sweeping of the first mirror 1714a and the second mirror 1714b are synchronized. For example, the first mirror 1714a and the second mirror 1714b may point at the same angle laterally. Optionally, the first camera 1702a and the second camera 1702b are synchronized to take images at the same time. Optionally, the system may include a synchronizer 1720 synchronizing movement of the mirrors 1714a, 1714b. For example, in some embodiments the synchronizer 1720 may include a single actuator that drives movement of both the first mirror 1714a and second mirror 1714b. For example, the synchronizer may include an axle. Optionally, the first mirror 1714a and second mirror 1714b may be moved by and/or mounted to the single axle. Alternatively or additionally, the first mirror 1714a and second mirror 1714b may be driven by a single actuator using one or more drive belts. For example, the belts may be low slip and/or low stretch and/or low recoil.

In some embodiments, the system includes a third camera and/or a third mirror sweeping a field of view of said third camera. Optionally, an axis of sweeping of the third mirror is colinear with the axis of sweeping of the first mirror 1714a and/or the axis of sweeping of the second mirror 1714b. Optionally, a focal length of the third mirror may be least 300 mm and/or the third lens may have a focal length greater than the first lens and wherein said third camera images through said third lens.

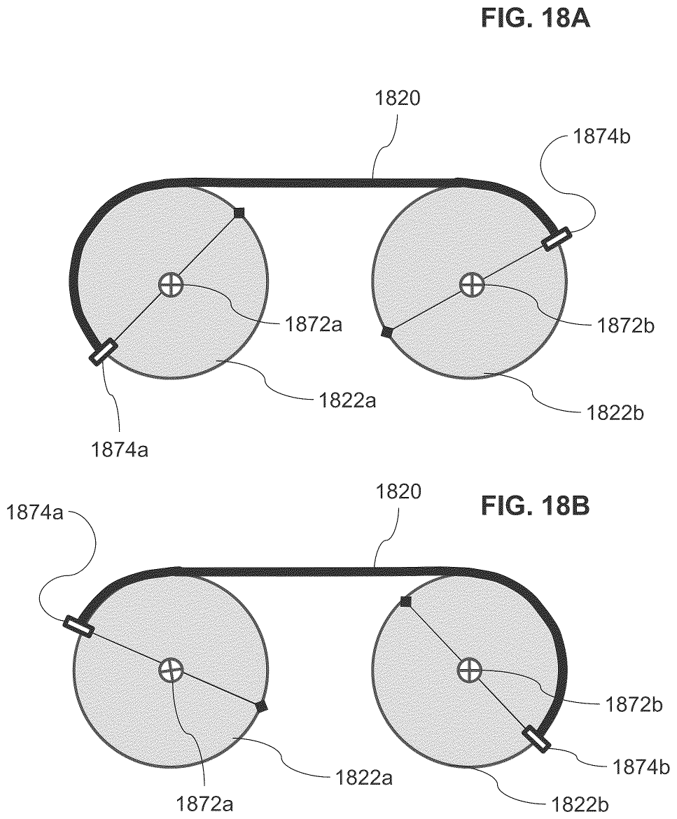

FIGS. 18A and 18B are schematic illustrations of a synchronizing system in accordance with an embodiment of the current invention. For example, rotation around two drive wheels 1822a, 1822b around two axes 1872a, 1872b synchronized by a drive belt 1820. For example, the belt 1820 may be low slip and/or low stretch and/or low recoil. For example, near a first end, the belt 1820 may be fixed to drive wheel 1822a by a connector 1874a. For example, the connector 1874a may include a screw and/or cement and/or a pin and/or another attachment mechanism. For example, near a second end, the belt 1820 may be fixed to drive wheel 1822b by a connector 1874b.

In some embodiments, the belt 1820 does not surround either of the drive wheels 1822a, 1822b. For example, the system may oscillate by rotating back and forth over 70 degrees (e.g., as illustrated in FIG. 18B the drive wheels 1822a, 1822b have illustrated has rotated 70 degrees clockwise with respect to drive wheels 1822a, 1822b as illustrated in FIG. 18A). In order to facilitate the synchronized 70-degree rotation, of wheels 1822a, 1822b, belt 1820 is wrapped partially around wheels 1822a and 1822b and/or fixed to the wheels at an attachment point (e.g., with a connector 1874a, 1874b). For example, the belt 1820 coves over the combined wheels a portion of the circumference which is least more than 70 degrees of the circumference of one wheel. When one wheel 1822a is turned, the belt 1820 turns the second wheel. Optionally, the turning is not dependent on friction between the belt 1820 and the wheel 1822a, 1822b. For example, tension on the belt 1820 between the wheels 1822a, 1822b is transferred to the connector 1874a, 1874b. Note that wheels 1822a, 1822b may include an actuator axle and a mirror axle and/or two mirror axles that are being synchronized.

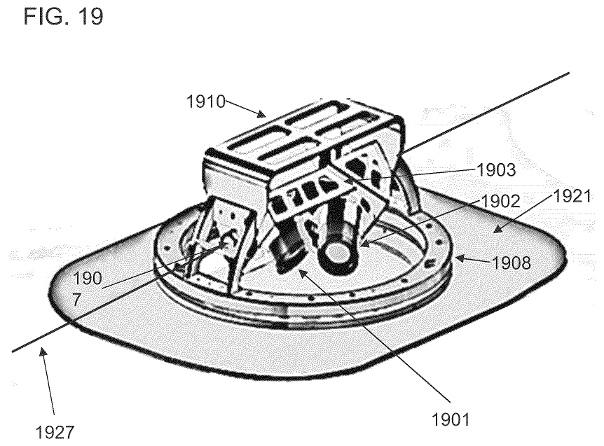

FIG. 19 shows a perspective view of an example of a compact sweeping imaging system according to the present invention. The exemplary system includes two rotating imaging sensors, which in this case include frame-based cameras 1901, 1902. The cameras are optionally mounted in a rigid frame 1903.

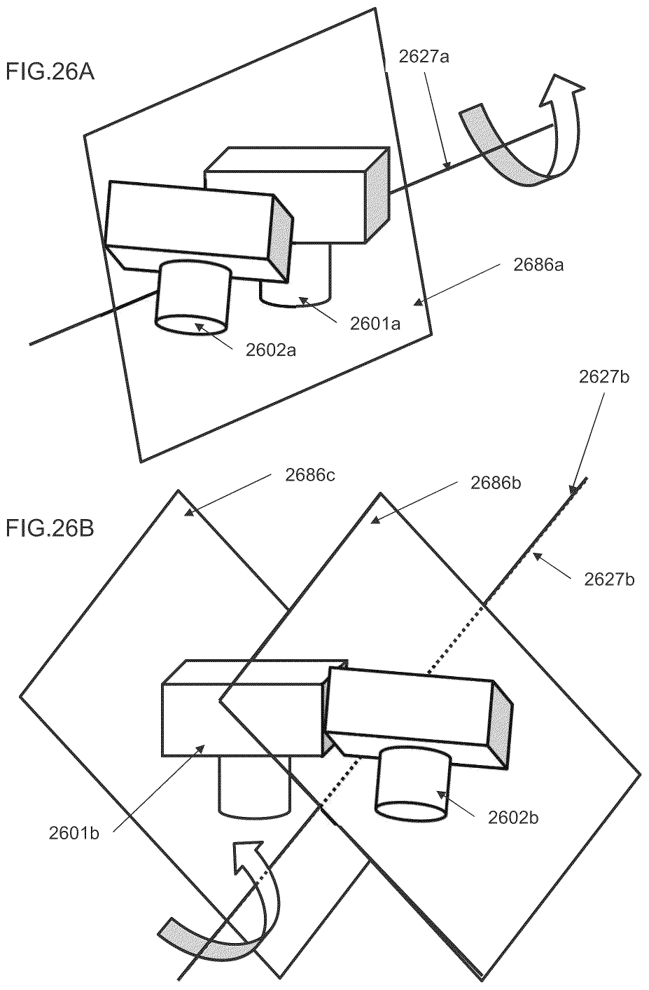

In some embodiments, the field of view of the cameras is optionally swept over a scene. For example, sweeping may include rotation of frame 1903 around an axis 1927. Optionally, the cameras 1901, 1902 are mounted with lines of site at different angles to the axis 1927. For example, camera 1901 is mounted with a line of which is perpendicular to the axis 1927 while camera 1902 is mounted with a line of sight at 45 degrees to the axis 1927. Optionally, the line of sight of camera 1901 and the line of sight of camera 1902 and the axis 1927 all fall in a single plane. Alternatively, the line of sight of camera 1901 and the line of sight of camera 1902 may each fall in a respective rotating plane (e.g. that the plane rotates as the line of sight is rotated around the axis) that is parallel to axis 1927. Optionally the rotating plane of camera 1901 is parallel to the rotating plane of camera 1902 for example as illustrated in FIG. 26B.

in some embodiments, rotation is driven by a motor 1907 mounted onto a motor mount 1910, for example as further depicted at FIG. 5. Alternatively or additionally, rotation may be driven by a DC motor and/or another actuator (for example a hydraulic actuator etc.) The angle of rotation of the cameras and/or the timing of each captured image are optionally controlled by the flight management computer. For example, the computer may adjust the angle and/or time and/or trajectory of the aircraft (e.g. speed and altitude) according to input of the area of interest which is to be covered and/or the resolution of the images which are to be obtained. In some embodiments, the flight management computer may provide an output including the flight lines which are to be followed, the height of the flight, the angle of rotation of the cameras (the extent of each sweep), the interval in which each image should be captured during the sweep (i.e., after how many degrees of rotation will an imaged be captured) and/or internal camera settings (for example resolution, zoom etc.). Optionally the motor is stopped in order to facilitate capturing a still image and/or after the still image is obtained the motor is reactivated to rotate the camera to the next calculated angle in order to capture the consecutive image. An example of a calculation to extract the flight protocol and system activation during its performance is shown in FIG. 13.

In some embodiments, the imaging system is installed on an aircraft's shooting hatch. Optionally, a stabilizer ring 1908 dampens vibrations occurring from the aircraft's body and/or provides stability and/or facilitates improved image quality. Optionally, the stabilizer includes a connector to the aircraft and a shock absorber. For example, stabilizer 608 includes two metal plates separated by shock absorbers. Optionally, frame 1903 is mounted to a lower surface 1921 of an aircraft via ring 1908. Optionally, a camera assembly may be placed on any of various locations on the underside of an aircraft. For example, the camera assembly may be place on a lower surface of the aircraft (for example a floor of a fuselage and/or a lower surface of a wing and/or a tail and/or a strut and/or the camera assembly may be mounted on a pod protruding from the aircraft.

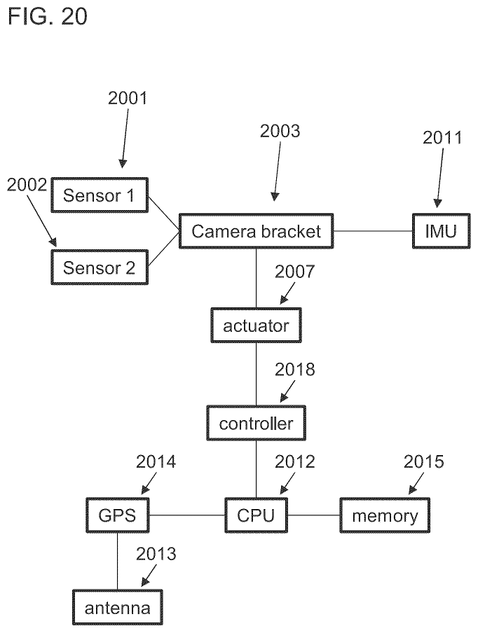

FIG. 20 is a schematic diagram illustrating some components of a system in accordance with an embodiment of the present invention:
Two sensors 2001, 2002 (e.g. cameras 1901, 1902 optionally including lenses and/or memory cards);
Actuator 2007 (e.g. Servo and/or DC motor 1907);
Navigation system 2011 (e.g. INS (Internal navigation system) and/or GNSS (Global Navigation Satellite System with Antenna) and/or IMU (Inertial Measurement Unit);
Flight and/or sensor management computer 2012.
GPS Antenna 2013
GPS receiver 2014
Flight Planning file 2015
Motor controller 2018

The system is connected to flight management computer 2012 to execute the activation of the system according to the calculated flight procedure as described for example in FIG. 8. The system's control board receives the flight execution file 2015 which contains, for example, the boundaries of the area of interest, the extracted flight lines, camera rotation angles (sweeps) and/or the intervals between sweeps in which images need to be captured. A GPS system provides the aircraft's position to the motor controller 2018. According to the flight execution file 2015, when the aircraft reaches the boundaries of the area of interest, the system switches to “operational mode”, in which the actuator 2007 rotates the sensors 2001, 2002 according to the extracted interval sweeps. Optionally, after each interval of the sweep, the actuator 2007 stops the cameras rotation to obtain a clear image and/or to reduce a smearing effect while an image is being taken. For example, after ensuring a complete stop, the controller gives the order to the camera to capture an image. The collected data (GPS data, angle data and/or images) is stored on a computer or on the camera's SD/compact-flash card. Optionally, each captured image is saved with a file name to enable construction of aerial maps and 3D mapping by software such as Accute3D (purchased by Bentley), PIX4D, Agisoft and SkyLine.

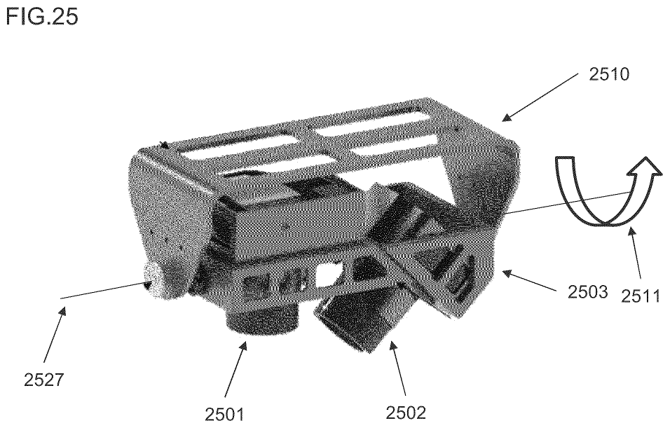

In some embodiments the actuator 2007 is connected to a bearing and to rotate the camera's back and forth, for example as displayed in FIG. 25A. The motor controller 2018 is responsible for the actuator's 2007 activation after it receives the command from the flight management computer 2012. For example, the commands may be synchronized with position, based on the GPS location data. In some embodiments, an actuator moves the camera to its position and/or waits for the camera to reach a full stop (for example it may wait a time ranging between 10 to 200 milliseconds and/or between 200 to 300 millisecond and/or between 200 to 800 milliseconds. For example, stopping may facilitate capturing the image when there is minimal camera movement (e.g. to prevent smearing effects). An IMU 2011 is optionally installed on the camera bracket 2003 and/or moves along with it. The IMU 2011 optionally extracts the angles of each sensor 2001, 2002 when the images are being captured. The IMU 2011 data is also stored on the flight management computer 2012.

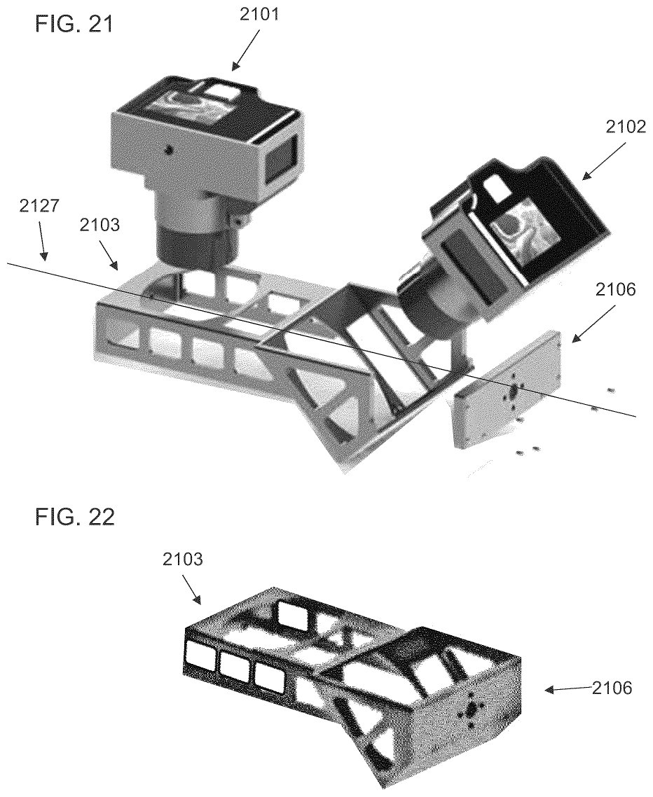

FIG. 21 illustrates two cameras 2101, 2102 and a camera bracket 2103 in accordance with an embodiment of the current invention. Optionally, a bracket 2103 tightly holds and/or locks the cameras 2101, 2102 and/or their lenses. For example, this may inhibit relative movement between the lenses and the cameras and/or relative movement between camera 2101 and 2102. In some embodiments, bracket 2103 fixes the cameras 2101, 2102 in their perspective angles with respect to each other. For example, camera 2101 is mounted at 90 degrees to an axis 2127 of rotation. Optionally, when the system is mounted on an aircraft, camera 2101 is facing nadir (for example, in the in the lowest part of the sweep camera 2101 may be facing vertically downward from a horizontally directed aircraft). Additionally or alternatively, the second camera 2102 faces at a finite angle to axis 2127. For example, in the embodiment of FIG. 21 camera 2102 is directed at 45 degrees to the axis 2127. Alternatively or additionally, a camera may be directed at an angle ranging, for example, between 40 to 50 degrees to the axis and/or between 30 to 40 degrees and/or between 10 to 30 degrees and/or between 50 to 80 degrees and/or between 0 to 10 degrees and/or between 80 to 90 degrees. Optionally, axis 2127 may be mounted parallel to the longitudinal axis (roll axis) of the aircraft and/or camera 2102 may be angled backwards and/or forward. Optionally, a locking member 2106 bolts over camera 2102 to hold it rigidly in bracket 2103.

FIG. 22 illustrates the bracket 2103 that secures the cameras and lenses in place in accordance with an embodiment if the current invention. The right space of the mount is designed to hold a camera at an oblique angle (e.g. 45 degrees), and the left space is designed to hold the vertical camera. The bracket is optionally made of aluminum. Optionally, bracket secures two cameras and their respective lens to prevent relative movement when the servo motor is rotating the bracket.

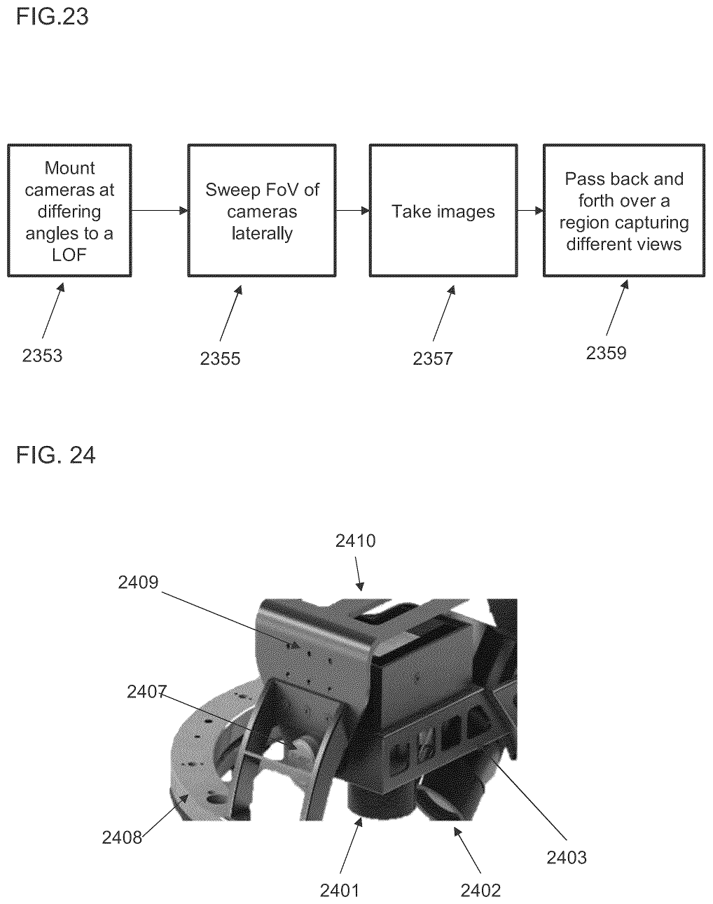

FIG. 23 is a flow chart illustration of a method of acquiring images for a 3D map. Optionally, two or more cameras are mounted 2353 on an aircraft at different angles to a line of flight (LoF). For example, one camera may be mounted 2353 approximately perpendicular to the LoF and the second camera may be mounted 2353 at an oblique angle to the LoF. Optionally, the fields of view FoV's of the cameras are swept 2355 laterally (e.g. transverse to the LoF). Optionally the FoV's of the cameras are synchronized. For example, the two cameras may be mounted in a bracket and/or moved simultaneously and/or a rotating mirror may sweep 2355 the FoV's of two cameras together. Optionally while sweeping the cameras will take 2357 images and/or particularly the camera that is mounted perpendicular to the LoF will capture images at various lateral angles of a region and/or the camera that is mounted oblique to line of flight will capture images of a first side of the scene over a first leg of the flight. Optionally the aircraft will pass 2359 back in an opposite (and/or if not directly opposite at least opposing) direction.

FIG. 24 discloses a motor 2407 (for example a servo, a DC motor and/or a brushless motor) and a height adjustable plate 2409 that enables various installations of the cameras above the aircraft's shooting hatch. A motor bracket 2410 optionally pivotally connects (for example via an axial passing across sides of the camera bracket 2403) to bracket. Bracket 2403 optionally holds two cameras 2401, 2402. Optionally, motor 2407, and/or a gear (i.e. Harmonic gear) and/or motor controller are housed next to the vertical camera's 2401 end.

FIG. 25A is a perspective view of two cameras 2501, 2502 mounted on a camera bracket 2503 optionally mounted on a motor bracket 2510 in accordance with an embodiment of the current invention. The entire camera bracket 2503 optionally rotates with respect to bracket 2510. For example, bracket 2503 rotates around axis 2527 which corresponds to an axle of motor bracket 2510 as is shown for example by the arrows 2511.

FIGS. 26A to and 26B illustrate two alternative mounting geometries for two cameras in accordance with embodiment of the current invention. For example, in the geometry of FIG. 26A, a line of sight Loss of a nadir mounted camera 2601a and a LOS of an obliquely mounted camera 2602a and a rotational axis 2627a are coplanar (all being included for example in plane 2686a). Optionally, camera 2601a is translated axially (e.g. along the direction of axis 2627a) with respect to camera 2602a. In contrast in the embodiment of FIG. 26B, nadir mounted camera 2601b is transversely translated with respect to oblique mounted camera 2602b. Optionally, the Loss of cameras 2601b and 2602b fall on separate parallel planes 2686b and 2686c. Alternatively or additionally as the cameras 2601b and 2602b are rotated around axis 2627b, the Loss of the cameras remain in the parallel planes 2686b and 2686c which rotate together around axis 2627b.

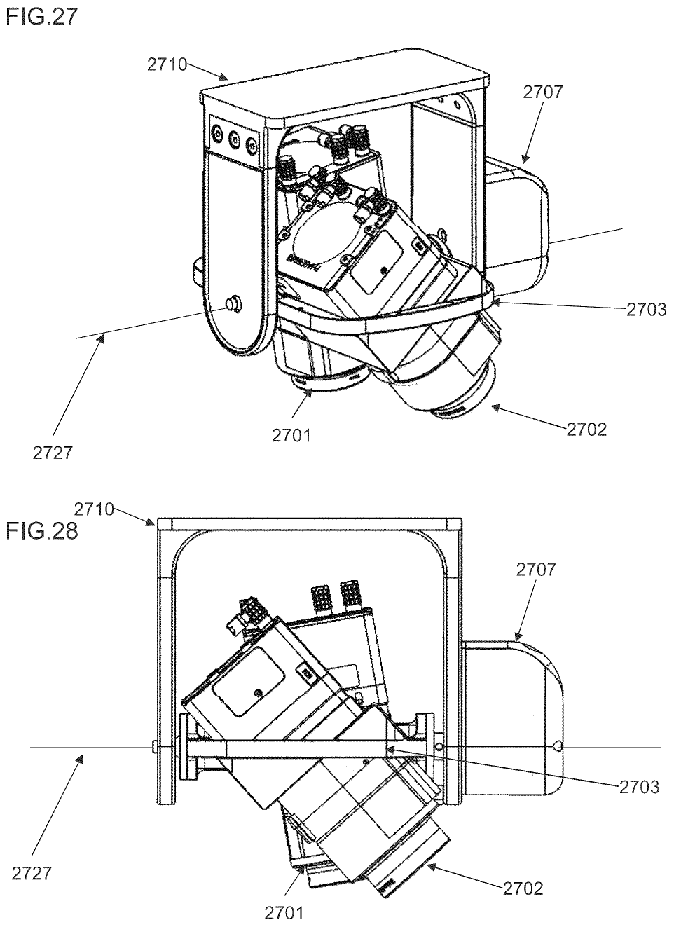

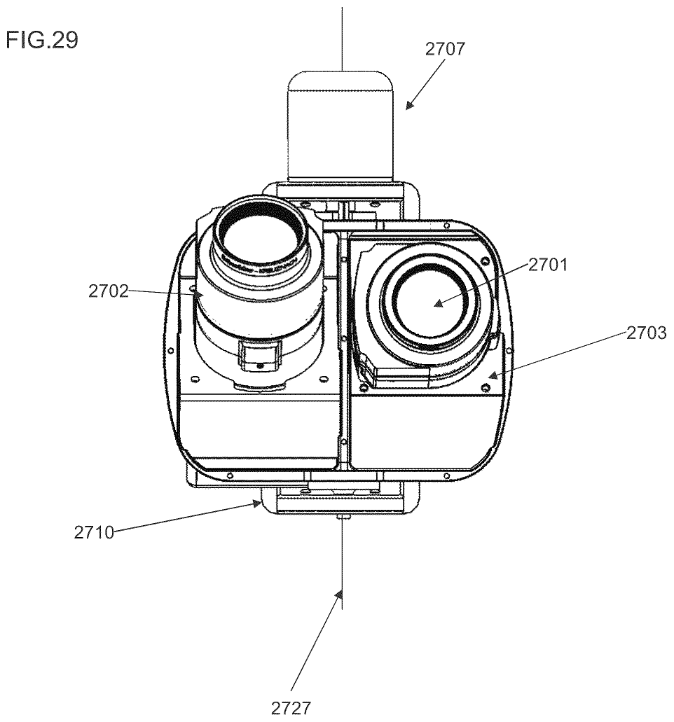

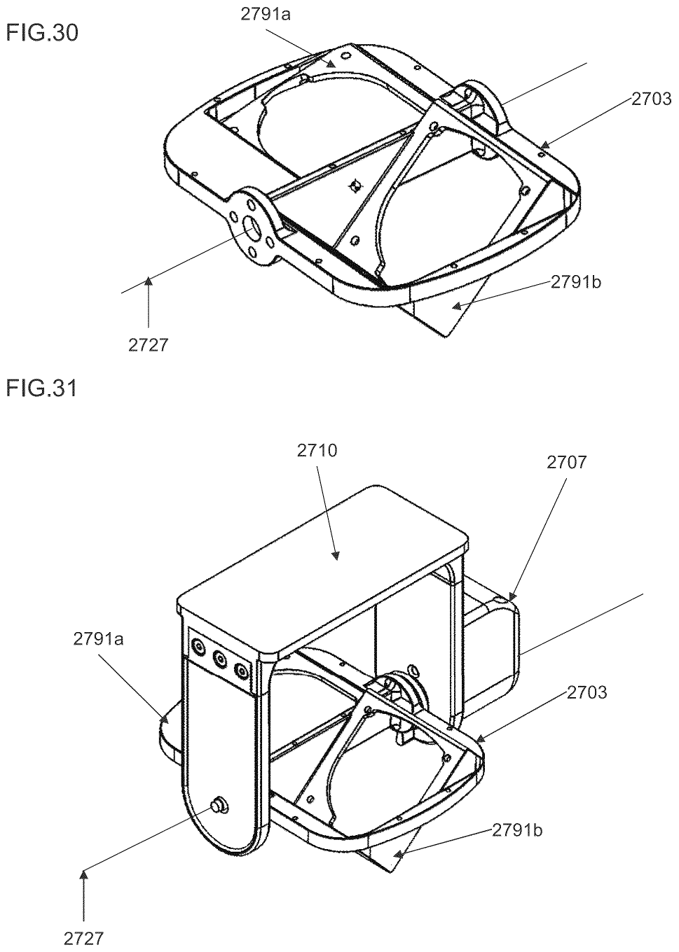

FIGS. 27 to 32 illustrate an embodiment of a 3D aerial photomapping imaging system in accordance with an embodiment of the current invention. In some embodiments, a 3D photomapping imaging system includes two cameras 2701, 2702 rotating sweeping around an axis 2727 wherein the cameras' LoS's and/or the axis 2727 of rotation are not is not coplanar. For example, the cameras may be translated from each other on a transverse line (e.g. perpendicular to the axis of rotation). In some embodiments, transversal mounting of the camera may make it possible to produce a small system. Optionally, camera 2701 is mounted nadir nearly and/or exactly perpendicular to the axis 2727 of rotation. For example, camera 2701 may be mounted at an angle ranging between 0 to 5 degrees to axis 2727 and/or between 5 to 15 degrees. Optionally, camera 2702 is mounted at a higher angle to axis 2727 for example ranging between 15 to 35 degrees and/or between 35 to 55 degrees and/or between 55 to 75 degrees to axis 2727.

In some embodiments, cameras 2701 and 2702 are mounted on a mounting bracket 2703. For example, bracket 2703 may include a nadir mount 2791a for a nadir camera 2701 and/or an oblique mount 2791b for an oblique camera 2702. Optionally, bracket 2703 is rotationally attached to a motor (i.e. DC or Servo) bracket 2710 and/or rotation of bracket 2703 with respect to bracket 2710 around an axis 2727 is driven by a motor 2707. The nadir mount 2791a is optionally configured to hold a camera at a small angle to axis 2727 when compared to oblique mount 2791b. For example, mount 2791a may hold a camera at an angle ranging between 0 to 5 degrees to axis 2727 and/or between 5 to 15 degrees. Optionally, mount 2791b may hold a camera at an angle ranging between 15 to 35 degrees and/or between 35 to 55 degrees and/or between 55 to 75 degrees to axis 2727.

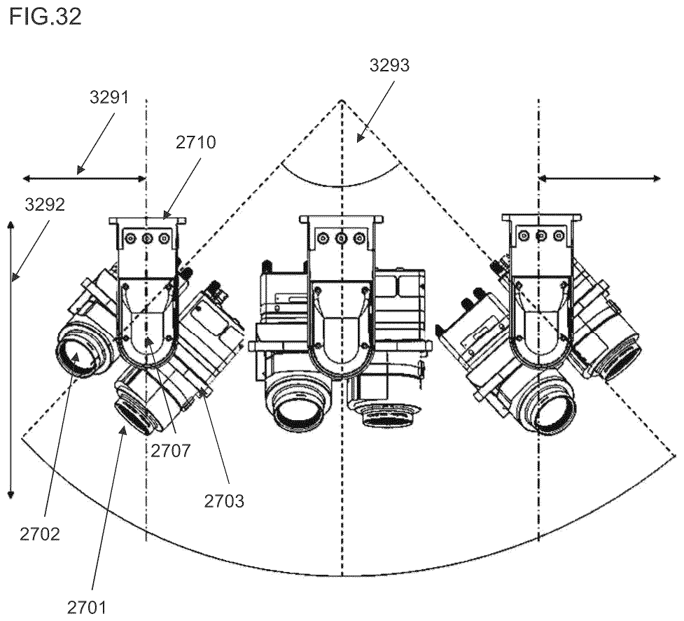

FIG. 32 illustrates three states of rotation of camera bracket 2703 with respect to servo bracket 2710. For example, bracket 2703 may rotate to an angle 3293 ranging between 0 to 15 degrees and/or between 0 to 30 degrees and/or between 0 to 45 degrees and/or between 0 to 60 degrees and/or between 0 to 80 degrees. Additionally or alternatively, rotation may include rotation in an opposite direction (e.g. negative angles). For example, bracket 2703 may rotate to an angle 3293 ranging between 0 to −15 degrees and/or between 0 to −30 degrees and/or between 0 to −45 degrees and/or between 0 to 60 degrees and/or between 0 to −80 degrees. Optionally, the system may rotate over the same range in both directions. Alternatively or additionally, a system may rotate more in one direction than another. In some embodiments, a system may have a third camera. For example, a second oblique camera may be set up mounted tilting in an opposite direction from the first oblique camera (for example one backwards and the other forward). Optionally with the third camera the overlap of FOV's for adjacent LoF may be less than with only one oblique camera and/or the range of rotation may be less and/or the system may rotate only in one direction.

Optionally a vertical length 3292 of the imaging system perpendicular to axis 2727 may range between 50 to 150 mm and/or between 150 to 350 mm and/or between 350 to 500 mm. Optionally a horizontal width 3291 of the imaging system perpendicular to axis 2727 may range between 25 to 75 mm and/or between 75 to 175 mm and/or between 175 to 250 mm.

It is expected that during the life of a patent maturing from this application many relevant technologies will be developed and the scope of the terms are intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for three-dimensional mapping comprising:
a first camera imaging through a first lens of at least 180 mm focal length;
a second camera imaging through a second lens of at least 300 mm focal length, wherein a focal length of said second lens is greater than a focal length of said first lens;
a first mirror sweeping a field of view of said first camera in a direction between 80 to 90 degrees of a first axis of sweeping;
a second mirror sweeping a field of view of said second camera in a direction between 45 to 80 degrees of a second axis of sweeping wherein said first axis of sweeping and said second axis of sweeping are at least one of parallel and colinear;
wherein sweeping of said first mirror and said second mirror are synchronized.

2. The system of claim 1, wherein said first axis of sweeping and said second axis of sweeping are parallel and movement of said first mirror is synchronized to movement of said second mirror by a low recoil belt.

3. The system of claim 2, wherein a single actuator drives movement of both the first mirror and second mirror.

4. The system of claim 2, at least one point of said low recoil belt is permanently connected to a drive driving movement of at least one of said first mirror and said second mirror.

5. The system of claim 3, further comprising a third camera and a third mirror sweeping a field of view of said third camera and wherein an axis of sweeping of said third mirror is colinear with at least one of the axis of sweeping of the first mirror and the axis of sweeping of the second mirror.

6. The system of claim 5, further comprising a third lens of a focal length of at least 300 mm and having a focal length greater than said first lens and wherein said third camera images through said third lens.

7. The system of claim 6, wherein said third mirror directs the field of view of said third cameral at an angle between 45 to 80 degrees from said axis of sweeping of said third mirror and in a direction opposite an angle between said field of view of said second camera and said second axis of sweeping.

8. The system of claim 1, further comprising an aircraft and wherein said first axis of sweeping is parallel to a line of flight of the aircraft.

9. An imaging system for aerial 3D mapping comprising:
a camera bracket configured to hold exactly one nadir camera exactly one oblique camera rigidly immobile with respect to each other;
an actuator configured for simultaneously for sweeping a field of view of said nadir camera at an angle fixed nearly perpendicular to a single axis of said sweeping and said oblique camera at an acute angle fixed with respect to said single axis of sweeping thereby sweeping said field of view of said nadir camera over three directions and said field of view of said oblique camera over three directions;
a servo bracket holding said actuator and said camera bracket to an aircraft with said single axis of sweeping fixed parallel to a longitudinal axis of the aircraft;
a processor configured to control said sweeping as said aircraft passes over a region on a plurality of parallel lines of flight wherein said on each of said parallel lines of flight the aircraft passes only once in one of two opposite directions to capture overlapping images in only six directions on each of said plurality of parallel line of flight and to achieve overlapping views of said region in exactly nine directions over the plurality of lines of flight.

10. The system of claim 9, wherein said nadir camera is held by said camera bracket at an angle of between 80 to 100 degrees to said single axis of sweeping.

11. The system of claim 10, wherein said oblique camera is held at an oblique angle to said single axis of sweeping of between 15 to 75 degrees.

12. The system of claim 9, wherein said camera bracket further holds a lens of at least one camera of said oblique camera and said nadir camera immobile with respect to a body of said at least one camera.

13. The system of claim 9, wherein said servo bracket is mounted to an underside of said aircraft.

14. The system of claim 9, wherein the camera bracket is height adjustable to relative to the aircraft.

15. The system of claim 9, wherein the system does not include any oblique camera facing in a longitudinal direction other than longitudinal direction of said nadir camera.

16. The system of claim 9, wherein the system does not include any oblique camera facing in a longitudinal direction opposite said single longitudinal direction.

17. The system of claim 9, wherein said only six directions consist of three nadir left, nadir right and nadir directly down and exactly one of a first set three oblique directions and a second sets of three oblique directions wherein a first set of three oblique directions consists of forward left, forward right and directly forward and wherein a second set of three oblique directions consists of rearward left, rearward right and directly rearward.

18. The system of claim 9, wherein on a line of flight in a first direction the system captures images from three directions consisting of nadir left, nadir right, nadir directly down, in a given direction left, in the given direction right and angled down straight in the given direction and wherein on a line of flight in a direction opposite said first direction the system captures images from nadir left, nadir right, nadir directly down, in a direction opposite the given direction left, in the direction opposite the given direction right and angled down straight in the direction opposite the given direction.

19. A method of imaging a region of interest comprising: traveling over said region of interest along parallel lines of flight (LoF's), wherein the traveling includes passing by each of two opposing sides of the region of interest on said LoF's in each of two opposing directions, while taking images directed along the LoF's in only one of a forward or backwards oblique direction wherein said forward or backwards oblique direction is at an angle of between 15 to 75 degrees to said LoF's; and sweeping a field of view (FOV) of said images transversely to form overlapping images from 6 oblique directions; wherein taking images in a nadir direction while passing over said region of interest on said LoF's and sweeping the FOV of said images transversely to form overlapping images from 3 directions, wherein said nadir direction is at an angle of between 80 to 100 degrees to said LoF's.

20. The method of claim 19, wherein said overlapping images taken from said forward or backwards oblique and nadir direction are produced by exactly two cameras.
